(19) United States
(12) Patent Application Publication
(10) Pub. No.: US 2026/0012793 A1
(43) Pub. Date: Jan. 8, 2026

(54) IN-VEHICLE DEVICE, ROADSIDE DEVICE, VEHICLE-EXTERNAL DEVICE, SECURITY MANAGEMENT METHOD, AND COMPUTER PROGRAM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(72) Inventors: Akihiro OGAWA, Osaka-shi (JP); Kazuhiro KAKITO, Osaka-shi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(21) Appl. No.: 18/993,743

(22) PCT Filed: Jun. 1, 2023
(86) PCT No.: PCT/JP2023/020443

§ 371 Date: Jan. 13, 2025

(30) Foreign Application Priority Data
Jul. 15, 2022 (JP) 2022-113634

(51) Int. Cl. H04W 12/122; H04B 7/155; H04W 4/40; H04W 36/08; H04W 36/30; H04W 48/16

(52) U.S. Cl. CPC H04W 12/122; H04B 7/155; H04W 4/40; H04W 36/08; H04W 36/30; H04W 48/16

(57) ABSTRACT

An in-vehicle device configured to be installed in a vehicle, the in-vehicle device including a processor that is configured to: detect a cyberattack against the vehicle; manage a plurality of wireless interfaces for performing wireless communication with an outside of the vehicle; manage a plurality of relay stations that perform communication via any wireless interface of the plurality of wireless interfaces; and select a relay station of the plurality of relay stations that is connectable to the in-vehicle device, wherein the processor switches a communication path to a path that is routed via the relay station selected and that is different from a communication path that was in use when the cyberattack was detected when the processor detects the cyberattack.

### BACKGROUND

The present disclosure relates to an in-vehicle device, a roadside device, a vehicle-external device, a security management method, and a computer program. The present disclosure claims the benefit of priority based on Japanese Patent Application No. 2022-113634 filed on Jul. 15, 2022, which is incorporated herein by reference in its entirety.

Vehicles including in-vehicle devices having a communication function for communicating with the outside of the vehicles are becoming popular. Such a vehicle receives various types of information from external devices through the communication function. The in-vehicle device assists the driver in driving safely based on the received information, for example. Also, an automatic emergency call system (e.g., eCall service) for automatically notifying the closest emergency call center of the occurrence of a vehicle accident with use of the communication function of the in-vehicle device is known.

In the automatic emergency call system, the in-vehicle device automatically notifies the emergency call center of accident information upon detecting a vehicle accident in which the vehicle is involved. Upon receiving the notification, the emergency call center requests an ambulance center and the police to go into action according to the conditions of the accident. Thus, the time it takes for a rescue party to arrive at the accident site is reduced and the lifesaving rate is increased by the automatic notification even when occupants of the vehicle involved in the accident cannot make the emergency call. As described above, the automatic emergency call system serves as a lifesaving system and has an important role affecting human life. Accordingly, communication for the automatic notification can be considered as communication whose priority degree is relatively high.

On the other hand, such a vehicle may be a target for cyberattacks due to having the communication function. As a measure that is taken when a cyberattack against the vehicle is detected by the in-vehicle device, it is conceivable to shut off communication with the outside of the vehicle. However, in this case, there is a problem in that communication having a high degree of priority, such as the automatic notification, is also shut off.

WO 2017/029811 discloses a communication system in which a first server that provides a first service and a second server that provides a second service having a higher degree of priority than the first service provide the services to a terminal device via a base station device. WO 2017/029811is based on a premise that one base station device provides the terminal device with the plurality of services having different degrees of priority. In this configuration, the communication system shuts off the communication path between the first server and the base station device upon detecting an abnormality in the first server, in order to maintain the provision of the second service having a higher degree of priority. At this time, handover control for making handover of the terminal device to a base station device in an adjacent cell and control for changing the coverage of the cell of the base station device are also performed.

### SUMMARY

An in-vehicle device according to an aspect of the present disclosure is an in-vehicle device configured to be installed in a vehicle, the in-vehicle device including a processor that is configured to: detect a cyberattack against the vehicle; manage a plurality of wireless interfaces for performing wireless communication with an outside of the vehicle; manage a plurality of relay stations that perform communication via any wireless interface of the plurality of wireless interfaces; and select a relay station of the plurality of relay stations that is connectable to the in-vehicle device, wherein the processor switches a communication path to a path that is routed via the relay station selected and that is different from a communication path that was in use when the cyberattack was detected when the processor detects the cyberattack.

The present disclosure can be embodied not only as an in-vehicle device having these characteristic configurations, a roadside device, a vehicle-external device, a security management method, and a computer program, but also as a recording medium/storage medium including a program recorded thereon for causing a computer to execute characteristic steps executed by the in-vehicle device, the roadside device, or the vehicle-external device. Furthermore, the present disclosure can also be embodied as another system or device including the in-vehicle device, the roadside device, or the vehicle-external device.

### BRIEF DESCRIPTION OF THE DRAWINGS

FIG. 1 is a diagram for describing operations of a vehicle including an in-vehicle device according to a first embodiment while the vehicle is communicating with the outside of the vehicle.

FIG. 2 is a diagram for describing operations of the vehicle shown in FIG. 1 while the vehicle is communicating with the outside of the vehicle.

FIG. 3 is a diagram for describing the vehicle shown in FIG. 1.

FIG. 4 is a block diagram showing an example of a functional configuration of the in-vehicle device according to the first embodiment.

FIG. 5 is a diagram showing an example of a relay station table.

FIG. 6 is a block diagram showing an example of a hardware configuration of the in-vehicle device (GW device) according to the first embodiment.

FIG. 7 is a block diagram showing an example of a hardware configuration of a server device that communicates with the in-vehicle device.

FIG. 8 is a flowchart showing an example of a control structure of a program executed by the in-vehicle device shown in FIG. 6.

FIG. 9 shows details of the flow of step S1040 shown in FIG. 8.

FIG. 10 shows details of the flow of step S1050 shown in FIG. 8.

FIG. 11 is a diagram for describing operations of the in-vehicle device according to the first embodiment.

FIG. 12 is a block diagram showing an example of a functional configuration of an in-vehicle device according to a first variation.

FIG. 13 is a block diagram showing an example of a functional configuration of an in-vehicle device according to a second variation.

FIG. 14 is a diagram showing an overall configuration of a security management system according to a second embodiment.

FIG. 15 is a block diagram showing an example of a functional configuration of an in-vehicle device shown in FIG. 14.

FIG. 16 is a block diagram showing an example of a functional configuration of a roadside device shown in FIG. 14.

FIG. 17 is a block diagram showing an example of a hardware configuration of the roadside device shown in FIG. 14.

FIG. 18 is a flowchart showing an example of a control structure of a program executed by the in-vehicle device shown in FIG. 14.

FIG. 19 is a flowchart showing an example of a control structure of a program executed by the roadside device shown in FIG. 14.

FIG. 20 is a diagram showing an overall configuration of a security management system according to a third embodiment.

FIG. 21 is a block diagram showing an example of a functional configuration of a server device shown in FIG. 20.

FIG. 22 is a flowchart showing an example of a control structure of a program executed by a roadside device shown in FIG. 20.

FIG. 23 is a flowchart showing an example of a control structure of a program executed by the server device shown in FIG. 20.

FIG. 24 is a diagram showing an overall configuration of a security management system according to a fourth embodiment.

FIG. 25 is a diagram showing the overall configuration of the security management system according to the fourth embodiment.

FIG. 26 is a block diagram showing an example of a functional configuration of a server device shown in FIGS. 24 and 25.

FIG. 27 is a flowchart showing an example of a control structure of a program executed by the server device shown in FIGS. 24 and 25.

FIG. 28 shows details of the flow of step S4050 shown in FIG. 27.

FIG. 29 shows details of the flow of step S4060 shown in FIG. 27.

### DETAILED DESCRIPTION OF EMBODIMENTS

### Technical Problem

The communication system described in WO 2017/029811 relates to a measure that is taken when an abnormality has occurred in a server that provides a service. The measure is to shut off the communication path between the server in which the abnormality has occurred and the base station device as described above. That is to say, communication between a device in which an abnormality has occurred and the outside of the device is shut off. Accordingly, if the measure described in WO 2017/029811 is taken when a cyberattack against a vehicle is detected by an in-vehicle device, communication between the in-vehicle device and the outside of the vehicle is shut off. In this case, necessary communication is not maintained. Therefore, the above-described problem cannot be solved by the technology described in WO 2017/029811.

The present disclosure was made to solve the above-described problem, and has an object of providing an in-vehicle device, a roadside device, a vehicle-external device, a security management method, and a computer program that make it possible to maintain necessary communication even when a measure against a cyberattack is taken.

### Advantageous Effects of Disclosure

According to the present disclosure, it is possible to provide an in-vehicle device, a roadside device, a vehicle-external device, a security management method, and a computer program that make it possible to maintain necessary communication even when a measure against a cyberattack is taken.

### Description of Embodiments of the Present Disclosure

Preferred embodiments of the present disclosure are listed and described below. At least some of the following embodiments may be combined suitably.
(1) An in-vehicle device according to a first aspect of the present disclosure is an in-vehicle device installed in a vehicle, including: an attack detecting unit configured to detect a cyberattack against the vehicle; a wireless interface management unit configured to manage a plurality of wireless interfaces for performing wireless communication with the outside of the vehicle; a relay station management unit configured to manage relay stations that perform communication via any of the wireless interfaces; and a relay station selecting unit configured to select a relay station connectable to the in-vehicle device of the vehicle from the relay stations managed by the relay station management unit, wherein the wireless interface management unit includes a path switching unit, and if the attack detecting unit has detected the cyberattack, the path switching unit switches a communication path to a path that is routed via the relay station selected by the relay station selecting unit and is different from a communication path that was in use when the cyberattack was detected.

When a cyberattack against the vehicle is detected by the attack detecting unit, the communication path is switched to a path routed via a relay station. The path used for the cyberattack is blocked by switching the communication path to a path different from the path that was in use when the cyberattack was detected. Thus, it is possible to guard against the cyberattack. Moreover, communication with the outside is maintained via the path routed via the relay station, and therefore, it is possible to maintain necessary communication.
(2) In the configuration described above in (1), the plurality of wireless interfaces managed by the wireless interface management unit may include a first wireless interface for communicating with a base station and a second wireless interface for communicating with a relay station, and if the attack detecting unit has detected the cyberattack during communication with the base station via the first wireless interface, the path switching unit may switch the wireless interface used for wireless communication with the outside of the vehicle from the first wireless interface to the second wireless interface. Thus, it is possible to more effectively block the path used for the cyberattack.
(3) In the configuration described above in (1) or (2), the relay station selecting unit may calculate a communication requirement required for communication with a predetermined communication partner set in advance, and select a relay station that is connectable to the in-vehicle device of the vehicle and satisfies the calculated communication requirement from the relay stations managed by the relay station management unit. With this configuration, it is possible to select a relay station that satisfies a requirement for communication having a high degree of priority, for example, and therefore, it becomes easy to maintain necessary communication such as the communication having a high degree of priority.
(4) In any of the configurations described above in (1) to (3), the relay station management unit may further manage security strength of the relay stations, and the relay station selecting unit may select a relay station further based on the security strength. With this configuration, it is possible to select a relay station with strong security, and accordingly, it is possible to set a more secure communication path as the destination of switching.
(5) In any of the configurations described above in (1) to (4), the relay station management unit may further manage a predetermined index relating to security risks of the relay stations, and the relay station selecting unit may select a relay station further based on the predetermined index relating to the security risks. With this configuration as well, it is possible to set a more secure communication path as the destination of switching.
(6) In any of the configurations described above in (1) to (5), the relay stations managed by the relay station management unit may include a mobile station and a fixed station. With this configuration, it is possible to increase the number of selectable relay stations, and accordingly, it is possible to effectively maintain necessary communication.
(7) In any of the configurations described above in (1) to (6), the relay station selecting unit may include a relay station updating unit configured to update relay stations connectable to the in-vehicle device of the vehicle, and the relay station updating unit may determine whether or not communication with a currently connected relay station can be continued in an area in which the vehicle is going to travel, and select a new relay station according to a determination result. With this configuration, it is possible to keep necessary communication from being interrupted.
(8) In any of the configurations described above in (1) to (7), the relay station management unit may manage the relay stations with use of a relay station table including information of each relay station in an area in which the vehicle is going to travel, and the relay station selecting unit may select a relay station connectable to the in-vehicle device of the vehicle in the area in which the vehicle is going to travel, by referring to the relay station table. This configuration makes it easy to select the relay station connectable to the in-vehicle device.
(9) In the configuration described above in (8), the in-vehicle device may further include an obtaining unit configured to obtain a relay station map from an information processing device outside the vehicle by communicating with the information processing device, the relay station map being created by mapping relay stations that satisfy a predetermined requirement in an area including the area in which the vehicle is going to travel, and the relay station management unit may extract information regarding an area corresponding to the area in which the vehicle is going to travel, from the relay station map obtained by the obtaining unit, the information including the relay station table. With this configuration, the relay station selecting unit can effectively select a relay station connectable to the in-vehicle device by using the extracted relay station table.
(10) In the configuration described above in (8), the in-vehicle device may further include an obtaining unit configured to obtain a relay station map from an information processing device outside the vehicle by communicating with the information processing device, the relay station map including the relay station table and being created by mapping relay stations that satisfy a predetermined requirement in the area in which the vehicle is going to travel. With this configuration as well, it is possible to effectively select a relay station connectable to the in-vehicle device.
(11) An in-vehicle device according to a second aspect of the present disclosure is an in-vehicle device installed in a vehicle, including: an attack detecting unit configured to detect a cyberattack against the vehicle; a wireless interface management unit configured to manage a plurality of wireless interfaces for performing wireless communication with the outside of the vehicle; and a transmitting unit configured to transmit vehicle information to a roadside device outside the vehicle if the attack detecting unit has detected the cyberattack, the vehicle information including information regarding a communication path that was in use when the cyberattack was detected and information regarding the wireless interfaces managed by the wireless interface management unit. The wireless interface management unit includes a path switching unit configured to switch the communication path to a path that is routed via a specified relay station in response an instruction from the roadside device that has received the vehicle information.

Upon detecting a cyberattack, the in-vehicle device communicates with the roadside device and switches the communication path based on an instruction transmitted from the roadside device. By switching the communication path to block the path used for the cyberattack, it is possible to guard against the cyberattack. Moreover, communication with the outside is maintained via the path routed via the relay station, and therefore, it is possible to maintain necessary communication.
(12) A roadside device according to a third aspect of the present disclosure is a roadside device configured to communicate with an in-vehicle device installed in a vehicle, wherein the in-vehicle device transmits vehicle information to the outside of the vehicle upon detecting a cyberattack against the vehicle, the vehicle information including at least information regarding a communication path that was in use when the cyberattack was detected and information regarding wireless interfaces for performing wireless communication with the outside of the vehicle, the roadside device including: a relay station management unit configured to manage relay stations; a receiving unit configured to receive the vehicle information transmitted from the in-vehicle device; a relay station selecting unit configured to select a relay station that is connectable to the in-vehicle device of the vehicle and constitutes a path different from the communication path that was in use when the cyberattack was detected, from the relay stations managed by the relay station management unit based on the received vehicle information; and an instruction transmitting unit configured to transmit, to the in-vehicle device, an instruction to switch the communication path to a path routed via the relay station selected by the relay station selecting unit.

The roadside device transmits an instruction to switch the communication path to a path routed via a relay station to the vehicle that has detected a cyberattack. That is to say, the roadside device switches the communication path between the vehicle and the outside of the vehicle through remote control. With this configuration, it is possible to block the path used for the cyberattack and maintain communication between the vehicle and the outside of the vehicle using the path routed via the relay station.
(13) A vehicle-external device according to a fourth aspect of the present disclosure is a vehicle-external device configured to communicate with an in-vehicle device installed in a vehicle, the vehicle-external device including: an attack detecting unit configured to detect a cyberattack against the vehicle; a relay station management unit configured to manage relay stations that perform communication via any of a plurality of wireless interfaces installed in the vehicle; a relay station selecting unit configured to select a relay station connectable to the in-vehicle device from the relay stations managed by the relay station management unit, if the attack detecting unit has detected the cyberattack against the vehicle; and an instruction transmitting unit configured to transmit an instruction to switch a communication path to a path that is routed via the relay station selected by the relay station selecting unit and is different from a communication path that was in use when the cyberattack was detected.

The vehicle-external device monitors the vehicle from a remote place, and when the vehicle is subjected to a cyberattack, the attack detecting unit detects the cyberattack. Upon detecting the cyberattack against the vehicle, the vehicle-external device selects a relay station connectable to the in-vehicle device of the vehicle subjected to the cyberattack, from the relay stations managed by the relay station management unit. Furthermore, the vehicle-external device transmits, to the in-vehicle device, an instruction to switch the communication path to a path that is routed via the selected relay station and is different from the communication path that was in use when the cyberattack was detected. With this configuration, it is possible to block the path used for the cyberattack and maintain communication between the vehicle and the outside of the vehicle using the path routed via the relay station.
(14) A security management method according to a fifth aspect of the present disclosure is a security management method to be performed by an in-vehicle device installed in a vehicle, the method including: a step of detecting a cyberattack against the vehicle with use of the in-vehicle device; a step of, if the cyberattack has been detected in the detecting step, selecting a relay station connectable to the in-vehicle device with use of the in-vehicle device from relay stations that perform communication via any of a plurality of wireless interfaces for performing wireless communication with the outside of the vehicle; and a step of switching a communication path with use of the in-vehicle device to a path that is routed via the relay station selected in the selecting step and is different from a communication path that was in use when the cyberattack was detected.
(15) A computer program according to a sixth aspect of the present disclosure causes a computer installed in a vehicle to function as: an attack detecting unit configured to detect a cyberattack against the vehicle; a wireless interface management unit configured to manage a plurality of wireless interfaces for performing wireless communication with the outside of the vehicle; a relay station management unit configured to manage relay stations that perform communication via any of the wireless interfaces; and a relay station selecting unit configured to select a relay station communicably connectable to the computer from the relay stations managed by the relay station management unit, wherein the wireless interface management unit includes a path switching unit, and if the attack detecting unit has detected the cyberattack, the path switching unit switches a communication path to a path that is routed via the relay station selected by the relay station selecting unit and is different from a communication path that was in use when the cyberattack was detected. Thus, it is possible to guard against the cyberattack. Moreover, communication with the outside is maintained via the path routed via the relay station, and therefore, it is possible to maintain necessary communication.

### Details of Embodiments of the Present Disclosure

The following describes specific examples of an in-vehicle device, a roadside device, a vehicle-external device, a security management method, and a computer program according to embodiments of the present disclosure with reference to the drawings. Note that, in the following embodiments, identical components are denoted by the same reference numeral. Those components have the same function and the same name. Accordingly, detailed descriptions thereof are not repeated.

### First Embodiment

### Overall Configuration

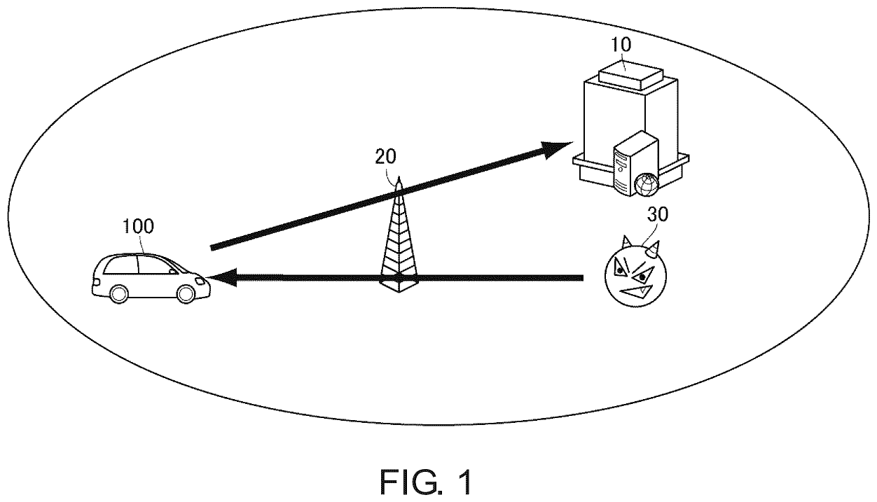

As shown in FIG. 1, in an automatic emergency call system that provides an eCall service, when a vehicle 100 that has a communication function for communicating with the outside of the vehicle has caused a crash accident, the vehicle 100 automatically notifies an emergency call center 10 of the occurrence of the accident. Specifically, when the vehicle 100 has caused a crash accident, the vehicle 100 automatically transmits data such as identification information, states, and positional information of the vehicle 100 to the emergency call center 10 through wireless communication in response to an airbag being set off due to the crash, for example. The identification information includes information such as the model of the vehicle and the color of the vehicle body. Examples of the states include whether or not a seatbelt was worn and the degree of the crash (crash sensor information indicating the impact of the crash). The positional information includes GPS (Global Positioning System) coordinate information.

It is necessary to maintain the state where the vehicle 100 is constantly connected to the emergency call center 10 in the automatic emergency call system. Therefore, cellular communication, which is wide-area communication, is usually used for the communication between the vehicle 100 and the emergency call center 10. In the cellular communication, the vehicle 100 communicates with a base station 20 (cellular base station) and communicates with the emergency call center 10 via the base station 20.

On the other hand, cyberattacks can be made from a wide area through wide-area communication such as the cellular communication. The vehicle 100 constantly connected to the emergency call center 10 through the cellular communication may be subjected to a cyberattack made by an attacker 30. As a measure that is taken when the vehicle is subjected to a cyberattack, it is conceivable to shut off all communications with the outside of the vehicle as described above. However, in this case, communication with the emergency call center 10 is also shut off.

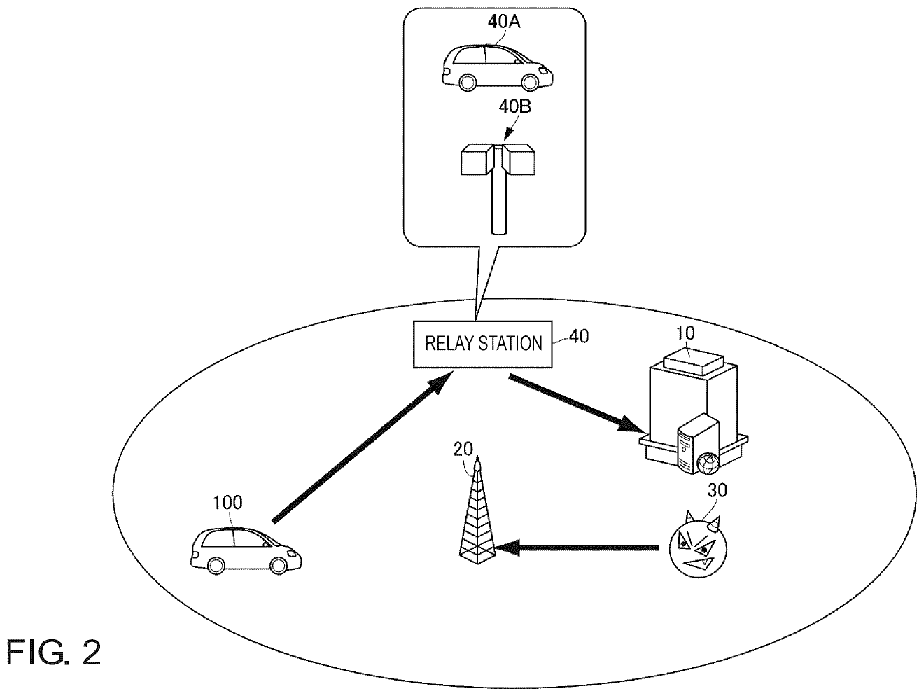

Referring to FIG. 2, in the present embodiment, the vehicle 100 subjected to a cyberattack switches the communication path used for the communication with the emergency call center 10 from a path routed via the base station 20 to a path routed via a relay station 40. Thus, the connection to the emergency call center 10 is maintained while the path used for the cyberattack is blocked. Examples of the relay station 40 include a mobile station 40A such as a vehicle and a fixed station 40B such as an infrastructure device (roadside device). Note that communication for which connection is maintained is not limited to the communication with the emergency call center 10. It is also possible to maintain connection for communication whose priority degree is relatively high. Communication for which it is necessary to maintain the connected state has a higher degree of priority than communication for which the connection may be temporarily interrupted, and accordingly, communication for which it is necessary to maintain the connected state may be hereinafter referred to as “high priority communication”. Another example of the high-priority communication is communication with an external device for causing the vehicle 100 to travel under remote control during autonomous driving.

The above-described processing performed by the vehicle 100 is executed by an in-vehicle device installed in the vehicle 100.

### Configuration of In-Vehicle Device 200

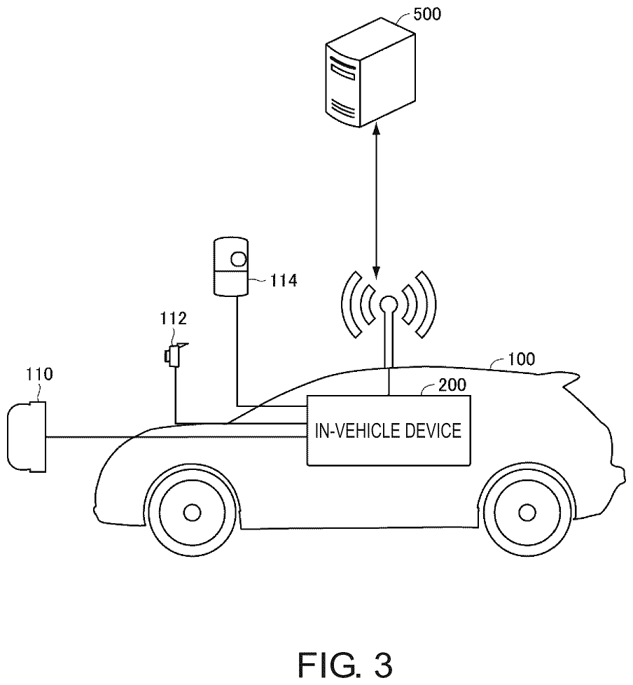

As shown in FIG. 3, an in-vehicle device 200 according to the present embodiment is installed in the vehicle 100 and executes various types of processing including the above-described processing. In addition to the in-vehicle device 200, various sensors such as a millimeter wave radar 110, an in-vehicle camera 112, and a LiDAR (Laser Imaging Detection and Ranging) 114 are installed in the vehicle 100. The in-vehicle device 200 collects sensor data from these sensors, and transmits the sensor data to a server device 500, which is an information processing device outside the vehicle, through wireless communication and receives various types of information from the server device 500, for example. The in-vehicle device 200 assists the driver in driving safely based on the collected sensor data or the information received from the server device 500, for example.

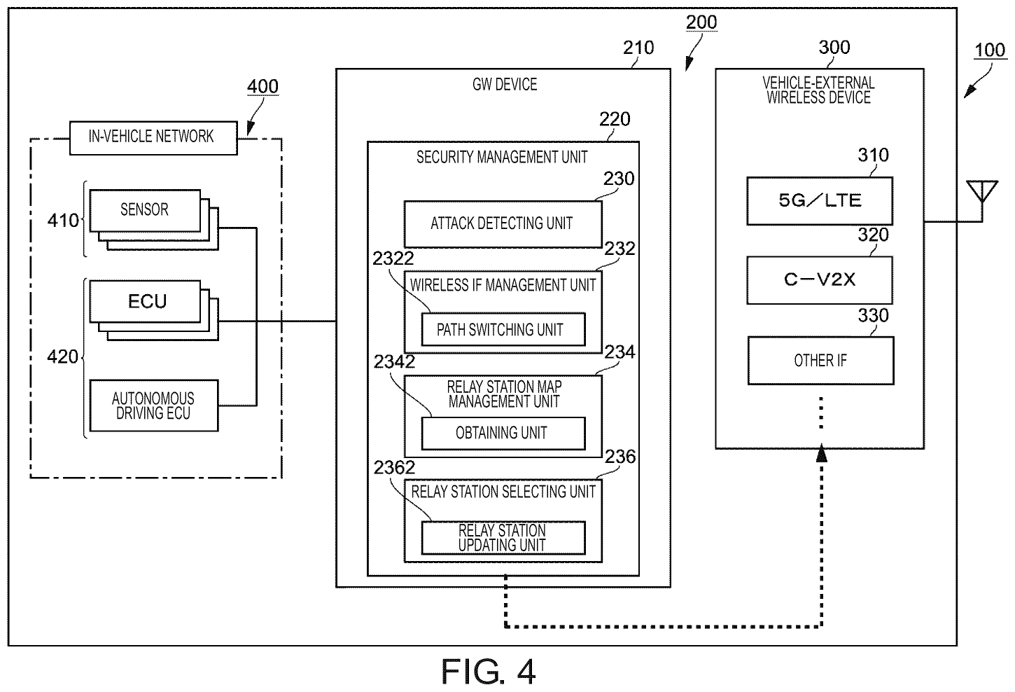

As shown in FIG. 4, the in-vehicle device 200 includes an in-vehicle GW (Gateway) device (hereinafter simply referred to as a “GW device”) 210 and a vehicle-external wireless device 300. In addition to the GW device 210, an in-vehicle network 400 that is a communication network including various sensors, various ECUs (Electronic Control Units), and the like is installed in the vehicle 100. A plurality of in-vehicle networks are usually installed in a vehicle. In FIG. 4, the in-vehicle network 400 is shown as a representative network of a plurality of in-vehicle networks, and the other in-vehicle networks are omitted.

The GW device 210 regulates data exchange between the plurality of in-vehicle networks by connecting the in-vehicle networks including the in-vehicle network 400 to each other. The in-vehicle network 400 includes a sensor group 410 that includes various sensors and an ECU group 420 that includes various ECUs. If the vehicle 100 has an autonomous driving function, the ECU group 420 includes an autonomous driving ECU.

The GW device 210 further includes a security management unit 220 as a functional unit. The security management unit 220 manages security of the vehicle 100. Specifically, the security management unit 220 detects a cyberattack against the vehicle 100, for example, and executes processing for switching the communication path used for communication with the outside of the vehicle. The security management unit 220 includes an attack detecting unit 230, a wireless interface (hereinafter “interface” will be abbreviated as “IF”) management unit 232, a relay station map management unit 234, and a relay station selecting unit 236.

The attack detecting unit 230 performs processing for detecting a cyberattack against an electronic device installed in the vehicle 100. Any detection method may be used to detect the cyberattack. For example, it is possible to detect the cyberattack by using an existing detection technology such as IDS (Intrusion Detection System) or IPS (Intrusion Prevention System). In this case, the content of communication data, a communication state, or the like is monitored, and the cyberattack is detected based on whether or not the monitoring result matches conditions of unauthorized access, for example. It is also possible to detect a DoS attack against the vehicle 100 by calculating the frequency of access (or communication volume) per unit time and comparing the calculation result with a threshold. The attack detecting unit 230 may also use a detection method other than the methods described above.

The wireless IF management unit 232 manages wireless IFs included in the vehicle-external wireless device 300 and controls the wireless IFs according to a result of selection performed by the relay station selecting unit 236. The wireless IF management unit 232 includes a path switching unit 2322 that switches a communication path. The path switching unit 2322 switches the communication path by controlling the wireless IFs according to the result of selection performed by the relay station selecting unit 236. The relay station map management unit 234 manages relay stations that perform communication via the wireless IFs included in the vehicle-external wireless device 300 with use of a relay station map. The relay station map is created by mapping positional information of relay stations on map data and includes a relay station table for managing various types of information regarding the relay stations. In the relay station table, IDs are assigned to vehicles or infrastructure devices (roadside devices) that satisfy minimum necessary security strength, processing performance, or communication requirements, and those vehicles or devices are managed as relay stations. The relay station table includes various types of information regarding relay stations in an area in which the vehicle 100 is going to travel. The relay station map is created by the server device 500 (see FIG. 3) and periodically or non-periodically provided to the in-vehicle device 200. The relay station map management unit 234 includes an obtaining unit 2342 that obtains the relay station map provided by the server device 500. The relay station map management unit 234 also has a function of managing the relay station map obtained by the obtaining unit 2342.

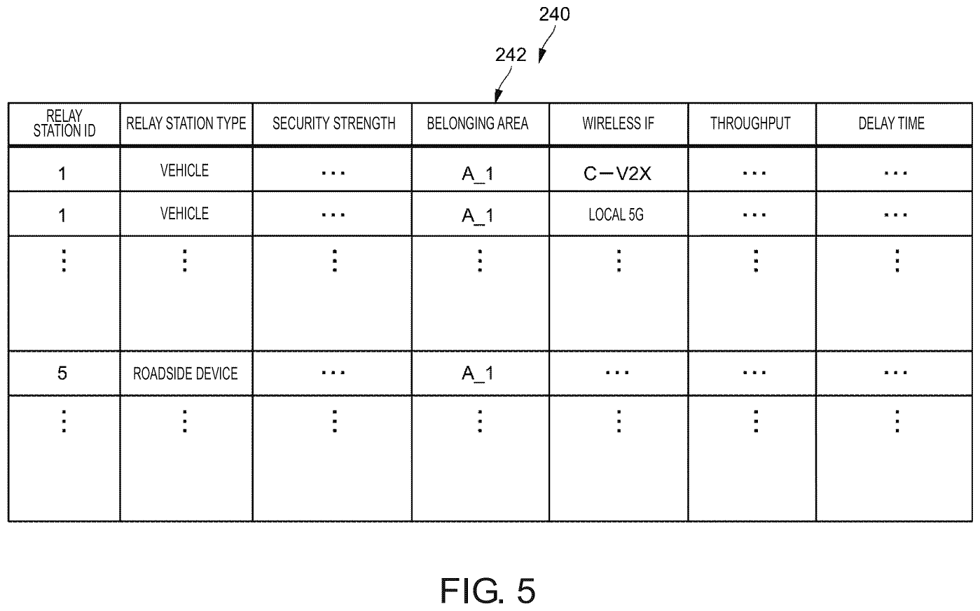

A relay station map 240 includes a relay station table 242 as shown in FIG. 5. The relay station table 242 includes columns showing “relay station ID”, “relay station type”, “security strength”, “belonging area”, “wireless IF”, “throughput”, and “delay time”, for example. The type of the relay station, which is either a vehicle (mobile station) or a roadside device (fixed station), is stored in the “relay station type” column. Information regarding security strength is stored in the “security strength” column. The information regarding the security strength is, for example, the version of firmware, an encryption scheme, the length of an encryption key, or the like. A rank corresponding to the security strength, which is determined based on these types of information, may also be stored in the “security strength” column. An area number assigned to an area to which the relay station belongs when the relay station map is sectioned into a plurality of areas is stored in the “belonging area” column. The name of a wireless IF included in the relay station is stored in the “wireless IF” column. Communication requirements of the corresponding wireless IF are stored in the “throughput” column and the “delay time” column. When the relay station includes a plurality of wireless IFs, the relay station table stores respective records corresponding to the wireless IFs. Accordingly, communication requirements that can be provided are managed for each of the wireless IFs.

When the relay station is a vehicle (mobile station), the belonging area changes as the vehicle serving as the relay station travels. The server device 500 (see FIG. 3) updates the relay station table 242 (relay station map 240) upon receiving a notification from the vehicle (mobile station). Note that a roadside device that serves as a fixed station may be configured to transmit items necessary to create the relay station table 242, such as the belonging area, to the server device 500. In this case, the frequency of transmission from a mobile station may be the same as or different from the frequency of transmission from a fixed station. If the frequencies of transmission differ from each other, it is preferable that the frequency of transmission from a mobile station (vehicle) is higher than the frequency of transmission from a fixed station (roadside device). The server device 500 also updates the relay station table 242 (relay station map 240) upon receiving a notification from a roadside device (fixed station). Upon updating the relay station map, the server device 500 transmits the updated relay station map to the vehicle 100.

The following description refers to FIG. 4 again. When the vehicle 100 is subjected to a cyberattack, the relay station selecting unit 236 selects a relay station that can be connected to the in-vehicle device 200 from the relay stations managed by the relay station map management unit 234. Specifically, when the cyberattack against the vehicle 100 is detected by the attack detecting unit 230, the relay station selecting unit 236 calculates communication requirements (e.g., the throughput or delay time) for high-priority communication, and selects a relay station that can be connected to the in-vehicle device 200 and satisfies the calculated communication requirements by referring to the relay station map (relay station table). When there is a plurality of relay stations that can be selected, a more secure relay station may be selected based on the security strength or a relay station may be selected based on a degree of priority set in advance. The relay station selecting unit 236 includes a relay station updating unit 2362. When communication with the relay station cannot be continued in an area in which the vehicle 100 is going to travel, the relay station updating unit 2362 reselects a relay station with which the vehicle 100 can communicate, by referring to the relay station map.

The vehicle-external wireless device 300 includes a plurality of wireless IFs (communication IFs) for performing wireless communication with the outside of the vehicle. The plurality of wireless IFs include a wireless IF 310 for performing cellular communication with an external device (vehicle-external device) with use of 5G (fifth generation mobile communication system) or LTE (Long Term Evolution), a wireless IF 320 for performing wireless communication with an external device with use of C-V2X, and another wireless IF 330, for example. An example of the other wireless IF 330 is an interface for Local 5G. Note that the wireless IFs included in the vehicle-external wireless device 300 are not limited to these, and may be other IFs. Also, the number of wireless IFs included in the vehicle-external wireless device 300 is not limited to this example.

There are various wireless IFs corresponding to respective communication systems. Cellular communication (4G (LTE)/5G) and LPWA (Low Power Wide Area) are known as wide-area communication systems, and DSRC (Dedicated Short Range Communications) and C-V2X are known as narrow-area communication systems. Furthermore, there are communication systems such as WiFi and Local 5G for local communication between wide-area communication and narrow-area communication. Local 5G differs from 5G, which is cellular communication, in that the Local 5G is operated by a company or a local government by its own other than telecommunication companies.

The vehicle-external wireless device 300 is monitored by the security management unit 220 of the GW device 210 to control the wireless IFs 310 to 330.

### Hardware Configuration of GW Device 210

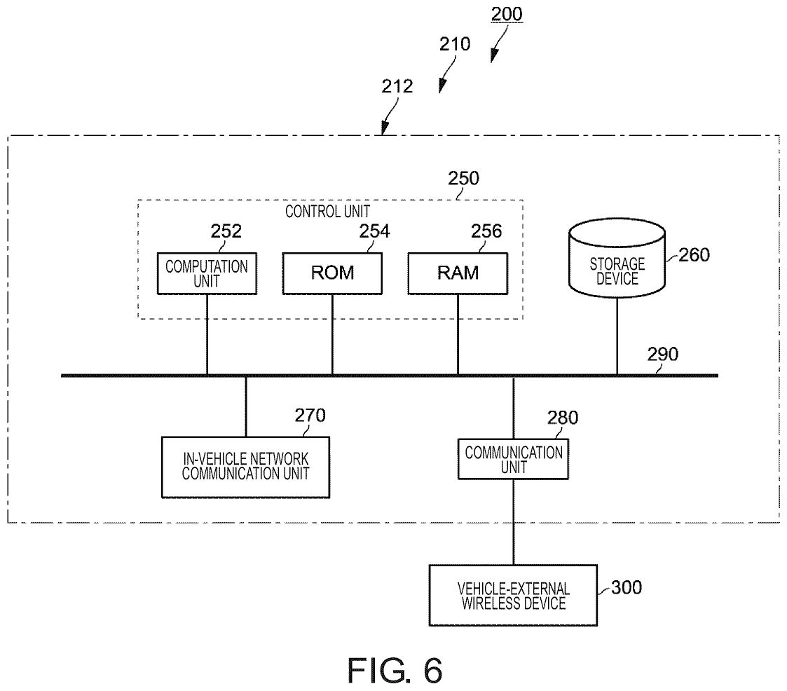

As shown in FIG. 6, the GW device 210 includes a computer 212. The computer 212 includes a control unit 250 that controls the entire GW device 210, a storage device 260 that stores various types of data, an in-vehicle network communication unit 270 that communicates with an in-vehicle network, and a communication unit 280 that communicates with the vehicle-external wireless device 300. The control unit 250, the storage device 260, the in-vehicle network communication unit 270, and the communication unit 280 are connected to a communication bus 290, and data is exchanged between these units via the communication bus 290.

The control unit 250 includes a computation unit 252, a ROM (Read-Only Memory) 254 storing a bootup program for the computer 212 and the like, and a RAM (Random Access Memory) 256 into which data can be written and from which data can be read as necessary. The computation unit 252 includes a CPU (Central Processing Unit) or an MPU (Micro Processing Unit) as a computation element (processor), for example. The storage device 260 includes a non-volatile memory such as a flash memory, for example. Software (computer program) to be executed by the computation unit 252 and various types of information (data) are stored in the ROM 254 or the storage device 260. The relay station map (relay station table) described above is stored in the storage device 260.

A computer program for causing the GW device 210 to function as each functional unit of the GW device 210 according to the present disclosure is stored in a predetermined storage medium such as a DVD (Digital Versatile Disc) or a USB (Universal Serial Bus) memory to be distributed, and transferred from the storage medium to the storage device 260. Alternatively, the computer program may be transmitted from an external device to the computer 212 through wireless communication performed with the outside of the vehicle and stored in the storage device 260.

The in-vehicle network communication unit 270 provides an IF for communicating with an in-vehicle network. The in-vehicle network communication unit 270 communicates with the in-vehicle network in accordance with a communication protocol such as CAN (Controller Area Network), for example. The GW device includes a plurality of in-vehicle network communication units 270 respectively corresponding to the plurality of in-vehicle networks. The GW device 210 (computer 212) relays data between the in-vehicle networks by transmitting data (message) received by an in-vehicle network communication unit from another in-vehicle network communication unit under control performed by the control unit 250. The communication unit 280 provides an IF for communicating with the vehicle-external wireless device 300.

### Hardware Configuration of Server Device 500

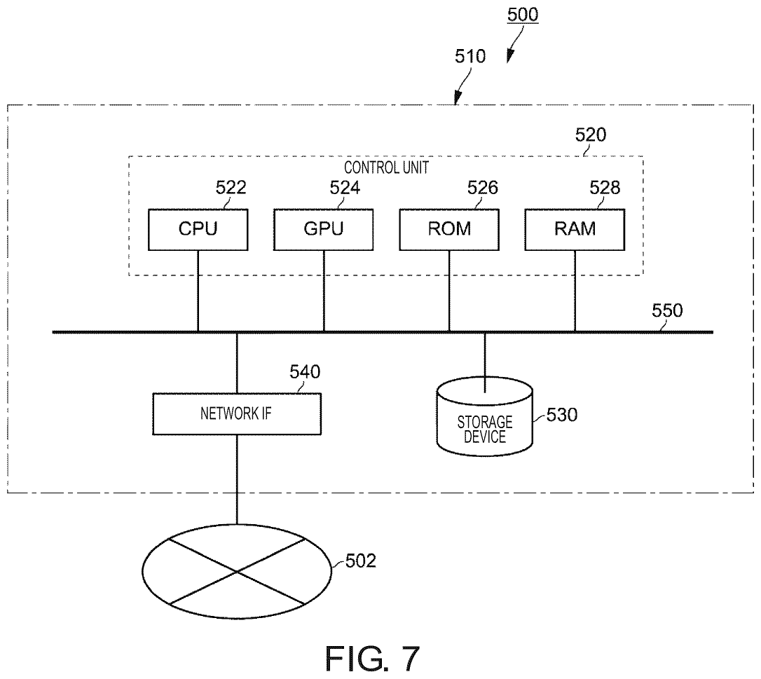

As shown in FIG. 7, the server device 500 includes a computer 510. The computer 510 includes a control unit 520, a storage device 530, and a network IF 540. The control unit 520 includes a CPU 522, a GPU (Graphics Processing Unit) 524, a ROM 526, and a RAM 528. The control unit 520, the storage device 530, and the network IF 540 are connected to a bus 550, and data is exchanged between these units via the bus 550.

The storage device 530 includes a non-volatile storage device such as a flash memory or a hard disk drive, for example. A computer program to be executed by the CPU 522 and various types of information are stored in the storage device 530. The network IF 540 provides access to a network 502 that enables communication with other terminals.

The server device 500 receives information necessary to create the relay station map (relay station table) from vehicles and roadside devices that may serve as relay stations via the network 502, and creates the relay station map or updates the created relay station map. The server device 500 distributes the created relay station map or the updated relay station map to vehicles through broadcasting, for example.

### Software Configuration

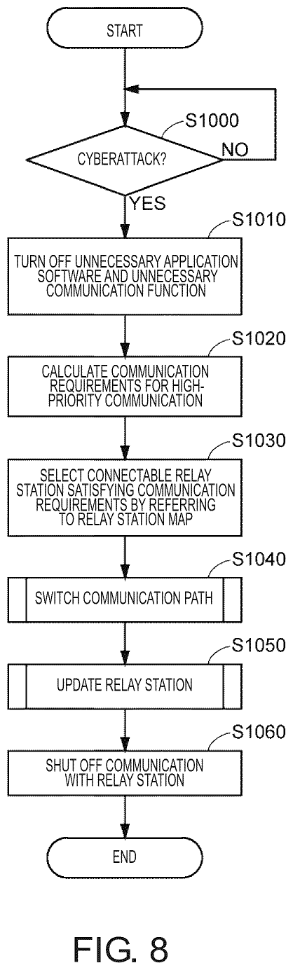

The following describes a control structure of a computer program that is executed by the in-vehicle device 200 (GW device 210) to maintain necessary communication even when the vehicle 100 is subjected to a cyberattack, with reference to FIGS. 8 to 10. This program starts when wireless communication with the outside of the vehicle is started, for example. In the following description, it is assumed that the in-vehicle device 200 has obtained the latest relay station map from the server device 500.

As shown in FIG. 8, this program includes: step S1000 in which the in-vehicle device 200 determines whether or not a cyberattack against the vehicle 100 has been detected, and keeps on standby until a cyberattack is detected; step S1010 that is executed if it is determined in step S1000 that a cyberattack has been detected, and in which unnecessary application software whose priority degree is not high is turned off or a communication function of the unnecessary application software is turned off while high-priority communication is maintained; step S1020 that is executed after step S1010 and in which communication requirements for the high-priority communication are calculated; step S1030 that is executed after step S1020 and in which a relay station that can be connected to the in-vehicle device 200 and satisfies the calculated communication requirements is selected with reference to the relay station map (relay station table); and step S1040 that is executed after step S1030 and in which processing for switching the communication path is executed.

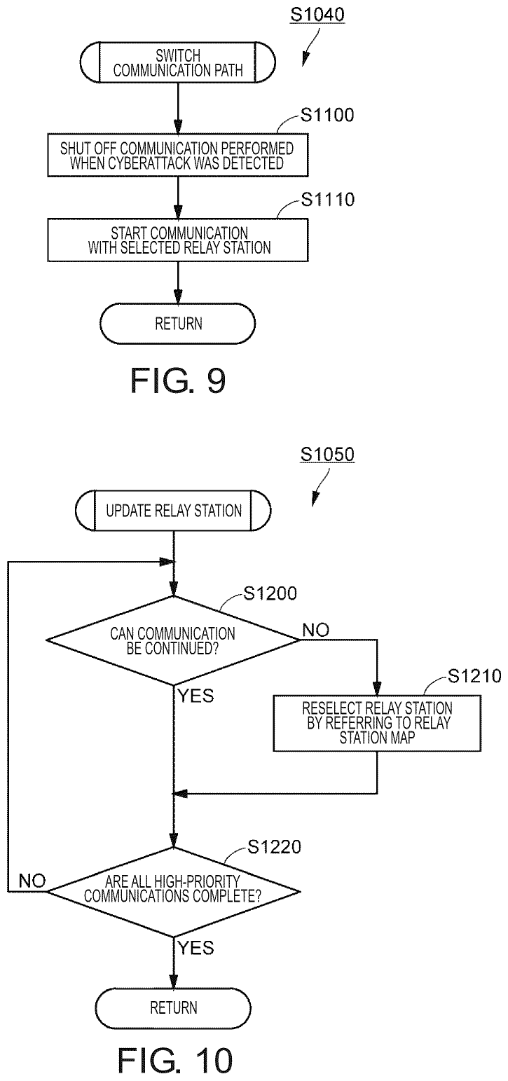

FIG. 9 shows details of the flow of step S1040 shown in FIG. 8. As shown in FIG. 9, this routine includes: step S1100 in which communication with a base station or a communication partner with which the vehicle 100 was communicating when the cyberattack was detected is shut off, and step S1110 that is executed after step S1100 and in which communication with the selected relay station is started and then this routine ends.

Referring back to FIG. 8, this program includes: step S1050 that is executed after step S1040 and in which processing for updating the relay station is executed; and step S1060 that is executed after step S1050 and in which communication with the relay station is shut off and this program ends.

FIG. 10 shows details of the flow of step S1050 shown in FIG. 8. As shown in FIG. 10, this routine includes: step S1200 in which it is determined whether or not communication with the currently connected relay station can be continued in an area in which the vehicle 100 is going to travel, and the control flow branches according to the determination result; step S1210 that is executed if it is determined in step S1200 that the communication cannot be continued, and in which a relay station that can be connected to the in-vehicle device 200 and satisfies the calculated communication requirements is reselected with reference to the relay station map (relay station table); and step S1220 that is executed if it is determined in step S1200 that the communication with the relay station can be continued, or is executed after step S1210, and in which it is determined whether or not all high-priority communications have been complete, and the control flow branches according to the determination result.

When it is no longer necessary to maintain high priority communication because, for example, the vehicle 100 has stopped i.e., when no problems occur even if the communication is shut off, it is determined in step S1220 that the high-priority communication has been complete. In the automatic emergency call system, it is also possible to determine that high-priority communication has been complete, when the vehicle 100 has caused an accident and then completed an automatic notification to the emergency call center 10. If it is determined in step S1220 that all high-priority communications have not been completed, the control returns to step S1200. If it is determined in step S1220 that all high-priority communications have been complete, this routine ends.

### Operations

The in-vehicle device 200 according to the present embodiment operates as follows. The following describes a case where communication with the emergency call center is high-priority communication that needs to be maintained.

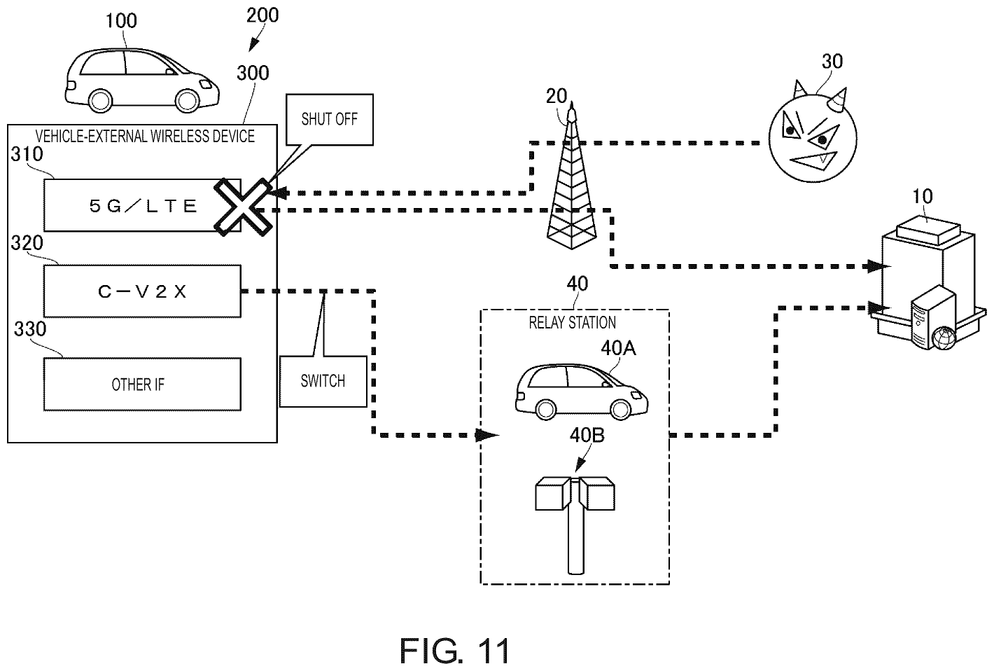

As shown in FIG. 11, the vehicle 100 is communicating with the base station 20 via the wireless IF 310 that performs cellular communication, and is connected to the emergency call center 10 via the base station 20. It is assumed that a cyberattack is made by an attacker 30 in this state in which the vehicle 100 is communicating with the outside of the vehicle through the wide-area communication.

The following description refers to FIG. 4. When the attack detecting unit 230 has detected the cyberattack against the vehicle 100 (YES in step $1000 in FIG. 8), the security management unit 220 turns off unnecessary application software or a communication function of the unnecessary application software (step S1010). The relay station selecting unit 236 calculates communication requirements for the communication (high-priority communication) with the emergency call center 10, which is a communication partner set in advance (step S1020), and selects a relay station that can be connected to the in-vehicle device 200 and satisfies the calculated communication requirements from the relay stations managed by the relay station map management unit 234, by referring to the relay station map (relay station table) (step S1030). The wireless IF management unit 232 (path switching unit 2322) shuts off communication performed when the attack was detected, and controls the vehicle-external wireless device 300 to start communication with the relay station selected by the relay station selecting unit 236 (steps S1100 and S1110 in FIG. 9).

The following description refers to FIG. 11 again. That is to say, the in-vehicle device 200 shuts off communication performed when the attack was detected, and switches the communication path to a path routed via the relay station 40. The communication path is switched by switching the wireless IF. That is to say, the vehicle-external wireless device 300 shuts off the cellular communication performed via the wireless IF 310 and switches the wireless IF used for communication with the outside of the vehicle to the wireless IF 320 (C-V2X) that enables inter-vehicle communication and road-vehicle communication. The wireless IF 320 starts communication with the relay station 40 (mobile station 40A or fixed station 40B) selected by the relay station selecting unit 236 (see FIG. 4) and maintains the state where the vehicle 100 is connected to the emergency call center 10 via the relay station 40. Note that the in-vehicle device 200 (GW device 210) may obtain the latest relay station map (relay station list) from the server device 500 (see FIG. 3) by transmitting a request for the transmission of the relay station map to the server device 500 after the cyberattack is detected and before the cellular communication via the wireless IF 310 is shut off.

The in-vehicle device 200 continues the communication with the emergency call center 10 via the relay station 40 until all high priority communications are complete, i.e., it is no longer necessary to maintain the connection to the emergency call center 10. When it is necessary to update the relay station (NO in step S1200 in FIG. 10), the in-vehicle device 200 reselects a relay station to which the relay station can be updated, by referring to the relay station map (step S1210). That is to say, the in-vehicle device 200 performs handover of the relay station according to the conditions of communication with the relay station.

When an updated relay station map is necessary, the in-vehicle device 200 causes the relay station with which the in-vehicle device 200 is currently communicating to transfer the latest relay station map provided by the server device 500 (see FIG. 3). The in-vehicle device 200 determines the next relay station that can be connected to the in-vehicle device 200 in an area in which the vehicle is going to travel, by referring to the transferred relay station map (relay station table), and performs handover of the relay station. When it is no longer necessary to maintain the connection to the emergency call center 10 (YES in step S1220 in FIG. 10), the in-vehicle device 200 shuts off the communication with the relay station (step S1060 in FIG. 8).

Note that the in-vehicle device 200 operates in a manner similar to the above-described manner even when the high-priority communication is communication other than communication with the emergency call center 10. Also, when there is a plurality of high-priority communications, the communication performed via the relay station is maintained until all the high-priority communications are complete.

### Effects of Present Embodiment

As apparent from the above description, the in-vehicle device 200 (GW device 210) according to the present embodiment has the following effects.

When a cyberattack against the vehicle 100 is detected by the attack detecting unit 230, the communication path is switched to a path routed via the relay station 40. The path used for the cyberattack is blocked by switching the communication path to a path different from the communication path that was in use when the cyberattack was detected. Thus, it is possible to guard against the cyberattack. Moreover, communication with the outside is maintained via the path routed via the relay station 40, and therefore, it is possible to maintain necessary communication.

The plurality of wireless IFs managed by the wireless IF management unit 232 include the wireless IF 310 for communicating with the base station 20 and the wireless IF 320 for communicating with the relay station 40. In response to the attack detecting unit 230 detecting a cyberattack while the vehicle is communicating with the base station 20 via the wireless IF 310, the path switching unit 2322 of the wireless IF management unit 232 switches the wireless IF used for wireless communication with the outside of the vehicle from the wireless IF 310 for cellular communication to the wireless IF 320 for inter-vehicle communication or road-vehicle communication. Thus, it is possible to more effectively block the path used for the cyberattack.

The relay station selecting unit 236 calculates communication requirements for communication with a predetermined communication partner (e.g., the emergency call center 10) set in advance, and selects a relay station that can be connected to the in-vehicle device 200 and satisfies the calculated communication requirements, from the relay stations managed by the relay station map management unit 234. With this configuration, it is possible to select a relay station that satisfies requirements for communication having a high degree of priority, for example, and therefore, it becomes easy to maintain necessary communication such as the communication having a high degree of priority.

The relay station map management unit 234 further manages security strength of each relay station, and the relay station selecting unit 236 selects a relay station further based on the security strength. With this configuration, it is possible to select a relay station with strong security, and accordingly, it is possible to set a more secure communication path as the destination of switching.

The relay stations managed by the relay station map management unit 234 include the mobile station 40A and the fixed station 40B. With this configuration, it is possible to increase the number of selectable relay stations, and accordingly, it is possible to effectively maintain necessary communication.

The relay station selecting unit 236 includes the relay station updating unit 2362 that updates relay stations connectable to the in-vehicle device 200, and the relay station updating unit 2362 determines whether or not communication with the currently connected relay station can be continued in an area in which the vehicle 100 is going to travel, and selects a new relay station according to the determination result. With this configuration, it is possible to keep necessary communication from being interrupted.

The relay station map management unit 234 manages relay stations by using the relay station table (relay station map) including information of each relay station included in the area in which the vehicle 100 is going to travel, and the relay station selecting unit 236 selects a relay station that can be connected to the in-vehicle device 200 in the area in which the vehicle 100 is going to travel, by referring to the relay station table. This configuration makes it easy to select the relay station that can be connected to the in-vehicle device 200. Furthermore, the use of the relay station map (relay station table) facilitates seamless switching of the communication path when a cyberattack is detected.

The in-vehicle device 200 obtains the relay station map created by mapping relay stations that satisfy predetermined requirements (e.g., minimum necessary security strength, processing performance, or communication requirements) in the area in which the vehicle 100 is going to travel, from the server device 500 outside the vehicle by communicating with the server device 500. The obtained relay station map includes the relay station table. With this configuration, it is possible to effectively select a relay station that can be connected to the in-vehicle device 200 based on the relay station map (relay station table).

### First Variation

In the above-described embodiment, an example is described in which the server device manages the relay station map and distributes the relay station map to the vehicle. However, the present disclosure is not limited to this embodiment. For example, the in-vehicle device may also be configured to create and manage the relay station map. An in-vehicle device having such a function is described in a first variation.

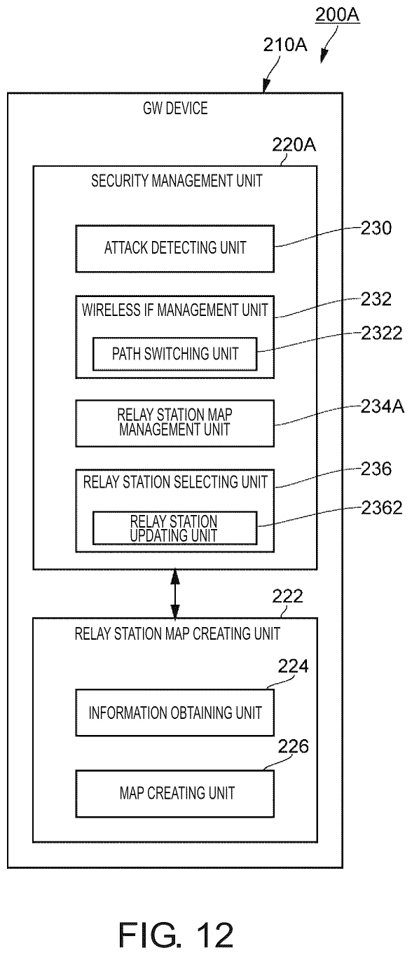

As shown in FIG. 12, an in-vehicle device 200A according to the first variation includes a GW device 210A instead of the GW device 210 (see FIG. 4). The GW device 210A includes a security management unit 220A and a relay station map creating unit 222 as functional units. The security management unit 220A differs from the security management unit in the first embodiment in that the security management unit 220A includes a relay station map management unit 234A instead of the relay station map management unit 234 (see FIG. 4). The other configurations are the same as those in the first embodiment.

The relay station map management unit 234A manages a relay station map created by the relay station map creating unit 222. The relay station map management unit 234A further manages relay stations that perform communication via the wireless IFs included in the vehicle-external wireless device, with use of the relay station map.

The relay station map creating unit 222 includes an information obtaining unit 224 and a map creating unit 226. The information obtaining unit 224 obtains (receives) information necessary to create a relay station map (relay station table) from vehicles or roadside devices that may serve as relay stations. The map creating unit 226 creates the relay station map based on the obtained information or updates the created relay station map.

With this configuration, the in-vehicle device 200A can switch the communication path to a path routed via a relay station even when it is not possible to obtain a relay station map from the server device. Note that the relay station map management unit 234A may also be configured to further obtain a relay station map from the server device as in the first embodiment. In this case, if the in-vehicle device 200A can obtain the relay station map from the server device, the in-vehicle device 200A can select a relay station with use of the relay station map obtained from the server device.

Note that the security management unit 220A may also be configured to include the relay station map creating unit 222.

### Second Variation

An in-vehicle device according to a second variation differs from the in-vehicle device in the above embodiment in that the in-vehicle device according to the second variation extracts map information necessary for the vehicle from relay station map information obtained from the server device, and uses the extracted map information as a relay station map.

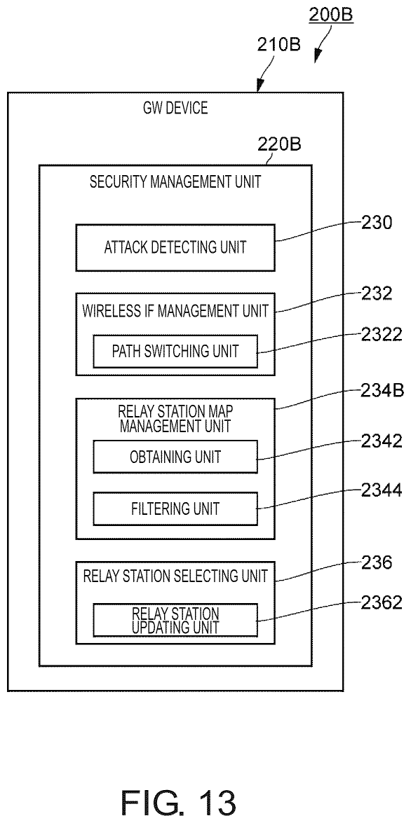

As shown in FIG. 13, an in-vehicle device 200B according to the second variation includes a GW device 210B instead of the GW device 210 (see FIG. 4). The GW device 210B includes a security management unit 220B as a functional unit instead of the security management unit 220 (see FIG. 4). The security management unit 220B includes a relay station map management unit 234B instead of the relay station map management unit 234 (see FIG. 4). The relay station map management unit 234B includes an obtaining unit 2342 that obtains relay station map information from the server device and a filtering unit 2344 that extracts information necessary for the vehicle as a relay station map by filtering the relay station map information obtained by the obtaining unit 2342. The server device creates the relay station map information covering a wide area, for example, and distributes the relay station map information. The in-vehicle device 200B extracts, for example, information regarding an area in which the vehicle is going to travel from the relay station map information covering the wide area and distributed by the server device. With this configuration, the in-vehicle device 200B can effectively select a relay station that can be connected to the in-vehicle device 200B with use of a relay station table included in the extracted relay station map.

### Third Variation

An in-vehicle device according to a third variation differs from the in-vehicle device in the above embodiment in that the in-vehicle device according to the third variation selects a relay station further based on a predetermined index relating to security risks of the relay station.

The relay station map management unit of the in-vehicle device further manages a predetermined index relating to security risks of the relay stations. The predetermined index may be an “index for evaluating the seriousness of vulnerability” defined in the CVSS (Common Vulnerability Scoring System), for example. In CVSSv3, AV (Attack Vector), AC (Attack Complexity), PR (Privileges Required), and UI (User Interaction) are defined as indexes relating to the difficulty of attack. Exploitability is calculated with use of these indexes.

The in-vehicle device selects a relay station giving further consideration to the calculated exploitability. Specifically, the relay station selecting unit of the in-vehicle device calculates communication requirements for communication with a predetermined communication partner (e.g., the emergency call center) set in advance, and selects a relay station from a set of relay stations that can be connected to the in-vehicle device of the vehicle and satisfy the calculated communication requirements, by selecting a combination of a relay station and a wireless IF that minimizes the exploitability. Alternatively, the relay station selecting unit may select a relay station by selecting a combination of a relay station and a wireless IF for which the exploitability is not higher than a certain value and that optimizes the calculated communication requirements.

By selecting a relay station further based on a predetermined index relating to security risks of the relay station as described above, it is possible to select a more secure communication path as the destination of switching.

### Second Embodiment

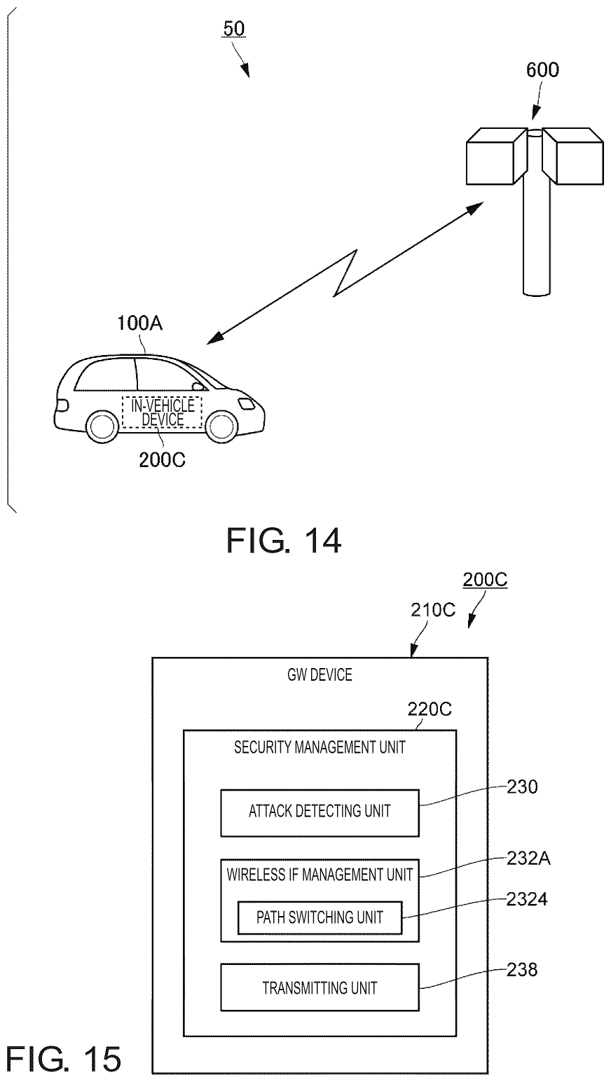

As shown in FIG. 14, a security management system 50 according to the present embodiment includes an in-vehicle device 200C installed in a vehicle 100A and a roadside device 600 that wirelessly communicates with the vehicle 100A. The present embodiment differs from the first embodiment in that the roadside device 600 takes on at least some of the functions of the security management unit described in the first embodiment. Although FIG. 14 shows one roadside device 600, the security management system may also include a plurality of roadside devices 600.

The vehicle 100A that has detected a cyberattack transmits vehicle information to the roadside device 600 and waits for an instruction from the roadside device 600. The roadside device 600, which is an infrastructure device, manages relay stations and selects a relay station based on the vehicle information received from the vehicle 100A. The roadside device 600 transmits information indicating the selected relay station together with a switching instruction to switch the communication path to the vehicle 100A. The vehicle 100A switches the communication path based on the switching instruction transmitted from the roadside device 600.

As shown in FIG. 15, the in-vehicle device 200C installed in the vehicle 100A includes a GW device 210C. The GW device 210C includes a security management unit 220C. The security management unit 220C includes an attack detecting unit 230, a wireless IF management unit 232A, and a transmitting unit 238.

The attack detecting unit 230 detects a cyberattack against an electronic device installed in the vehicle 100A as in the first embodiment. The wireless IF management unit 232A manages wireless IFs included in a vehicle-external wireless device and controls the wireless IFs to perform wireless communication with the outside of the vehicle. The wireless IF management unit 232A includes a path switching unit 2324 that switches the communication path. The path switching unit 2324 switches the communication path by controlling the wireless IFs in accordance with a switching instruction from the roadside device 600. The transmitting unit 238 transmits vehicle information to the roadside device 600 (see FIG. 14) in response to the attack detecting unit 230 detecting a cyberattack. The vehicle information transmitted by the transmitting unit 238 includes information regarding the communication path that was in use when the cyberattack was detected and information regarding the wireless IFs used for wireless communication with the outside of the vehicle. The information regarding the wireless IFs includes information regarding the wireless IFs managed by the wireless IF management unit 232A (e.g., types of the wireless IFs, communication requirements of the wireless IFs, etc.). The vehicle information may further include other information such as positional information indicating the current position of the vehicle 100A and communication requirements for high priority communication.

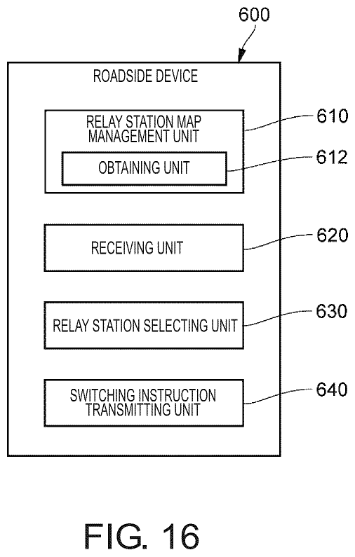

As shown in FIG. 16, the roadside device 600 includes a relay station map management unit 610, a receiving unit 620, a relay station selecting unit 630, and a switching instruction transmitting unit 640 as functional units. The relay station map management unit 610 manages relay stations with use of a relay station map. The relay station map management unit 610 includes an obtaining unit 612 that obtains the relay station map provided by a server device, for example. The receiving unit 620 receives the vehicle information transmitted from the in-vehicle device 200C (see FIG. 15). The relay station selecting unit 630 selects a relay station that can be connected to the in-vehicle device 200C of the vehicle 100A and constitutes a path different from the communication path that was in use when the cyberattack was detected, from the relay stations managed by the relay station map management unit 610 based on the received vehicle information. The switching instruction transmitting unit 640 transmits a switching instruction to switch the communication path to a path routed via the relay station selected by the relay station selecting unit 630 to the in-vehicle device 200C (GW device 210C).

### Hardware Configuration of Roadside Device 600

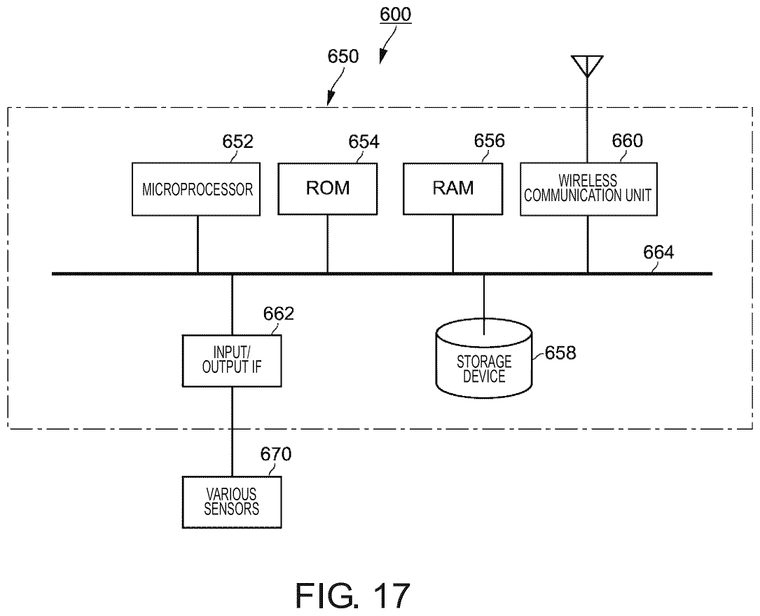

As shown in FIG. 17, the roadside device 600 is substantially a processor that includes a computer 650. The computer 650 includes a microprocessor 652, a ROM 654, a RAM 656, a non-volatile storage device 658 such as a flash memory, a wireless communication unit 660 that provides wireless communication with the outside of the roadside device, and an input/output IF 662. The microprocessor 652, the ROM 654, the RAM 656, the storage device 658, the wireless communication unit 660, and the input/output IF 662 are connected to a bus 664, and data is exchanged between these units via the bus 664. The roadside device 600 further includes various sensors 670 connected to the input/output IF 662. Examples of the various sensors 670 include a camera, a millimeter wave sensor, and a LiDAR.

Software (computer program) to be executed by the microprocessor 652 and various types of information (data) such as a relay station map are stored in the ROM 654 or the storage device 658. Each functional unit of the roadside device 600 is realized through software processing executed by the microprocessor 652 with use of hardware. The roadside device 600 obtains the relay station map from a server device by communicating with the server device via the wireless communication unit 660. The roadside device 600 may also be configured to receive information necessary to create the relay station map (relay station table) from vehicles and roadside devices that may serve as relay stations via the wireless communication unit 660, and create the relay station map or update the created relay station map.

### Software Configuration

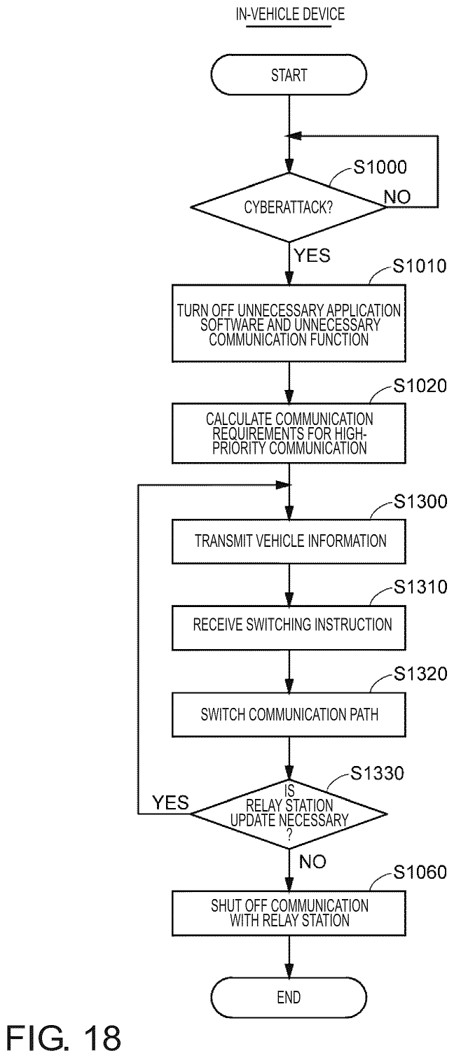

In the in-vehicle device 200C according to the present embodiment, a program shown in FIG. 18 is executed instead of the program shown in FIG. 8. The program shown in FIG. 18 includes steps S1300 to S1330 instead of steps S1030 to S1050 included in the program shown in FIG. 8. Processing performed in steps S1000 to S1020 and S1060 shown in FIG. 18 is the same as the processing performed in the corresponding steps shown in FIG. 8. The following describes differences.

This program includes: step S1300 that is executed after step S1020 and in which vehicle information including information regarding a communication path that was in use when the cyberattack was detected, information regarding wireless IFs used for wireless communication with the outside of the vehicle, communication requirements for high-priority communication, etc., is transmitted to the roadside device 600; step S1310 that is executed after step S1300 and in which a switching instruction transmitted from the roadside device 600 is received; step S1320 that is executed after step S1310 and in which the communication path is switched based on the received switching instruction; and step S1330 that is executed after step S1320 and in which whether or not the relay station needs to be updated is determined and the control flow branches according to the determination result. If it is determined in step S1330 that the relay station needs to be updated, the control returns to step S1300. If it is determined in step S1330 that the relay station need not be updated, the control proceeds to step S1060.

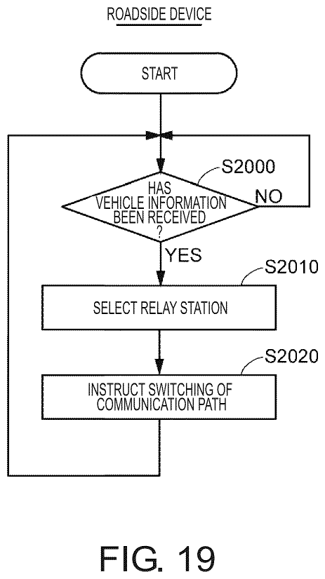

The following describes a control structure of a computer program that is executed by the roadside device 600 according to the present embodiment with reference to FIG. 19.

This program includes: step S2000 in which the roadside device determines whether or not vehicle information has been received, and keeps on standby until vehicle information is received; step S2010 that is executed if it is determined in step S2000 that vehicle information has been received, and in which a relay station that can be connected to the vehicle 100A (in-vehicle device 200C) transmitting the vehicle information and satisfies communication requirements for high priority communication is selected based on the received vehicle information with reference to a managed relay station map; and step S2020 that is executed after step S2010 and in which a switching instruction to switch the communication path to a path routed via the selected relay station is transmitted to the vehicle 100A and then the control returns to step S2000.

### Operations

The security management system 50 according to the present embodiment operates as follows.

Referring to FIG. 14, the vehicle 100A (in-vehicle device 200C) that has detected a cyberattack against the vehicle turns off unnecessary application software or a communication function of the unnecessary application software (step S1010 in FIG. 18), and calculates communication requirements for high-priority communication (step S1020). The in-vehicle device 200C transmits vehicle information to the roadside vehicle 600 (step S1300).

Upon receiving the vehicle information transmitted from the vehicle 100A (in-vehicle device 200C) (YES in step S2000 in FIG. 19), the roadside device 600 selects a relay station that can be connected to the vehicle 100A and satisfies the communication requirements for the high-priority communication based on the received vehicle information by referring to the relay station map (step S2010). The roadside device 600 transmits a switching instruction to switch the communication path to a path routed via the selected relay station to the vehicle 100A (in-vehicle device 200C) (step S2020).

Upon receiving the switching instruction from the roadside device 600 (step S1310 in FIG. 18), the in-vehicle device 200C switches the communication path based on the switching instruction (step S1320). Specifically, the in-vehicle device shuts off communication performed when the attack was detected, and starts communication with the relay station specified by the switching instruction. When it is necessary to update the relay station (YES in step S1330), the in-vehicle device transmits vehicle information to another roadside device 600 through road-vehicle communication. The other roadside device 600 that has received the vehicle information selects a relay station and transmits a switching instruction to switch the communication path to the vehicle 100A (steps S2010 and S2020 in FIG. 19). Upon receiving the switching instruction from the other roadside device 600, the vehicle 100A (in-vehicle device 200C) updates the relay station based on the received switching instruction. In this case, the communication performed when the attack was detected has been shut off, and therefore, the in-vehicle device 200C only executes processing for updating the relay station.

When it is no longer necessary to update the relay station because, for example, all high priority communications have been completed (NO in step S1330 in FIG. 18), the in-vehicle device 200C shuts off the communication with the relay station (step S1060).

### Effects

In the present embodiment, the roadside device 600 transmits an instruction to switch the communication path to a path routed via a relay station to the vehicle 100A that has detected a cyberattack. That is to say, the roadside device 600 switches the communication path between the vehicle 100A and the outside of the vehicle under remote control. With this configuration, it is possible to block the path used for the cyberattack and maintain communication between the vehicle 100A and the outside of the vehicle using the path routed via the relay station.

Note that the configuration described in the second embodiment may also be combined with the in-vehicle device according to the first embodiment and the variations thereof. That is to say, in the in-vehicle device according to the first embodiment and the variations thereof, it is also possible to switch the communication path based on a switching instruction from the roadside device 600 as necessary.

### Third Embodiment

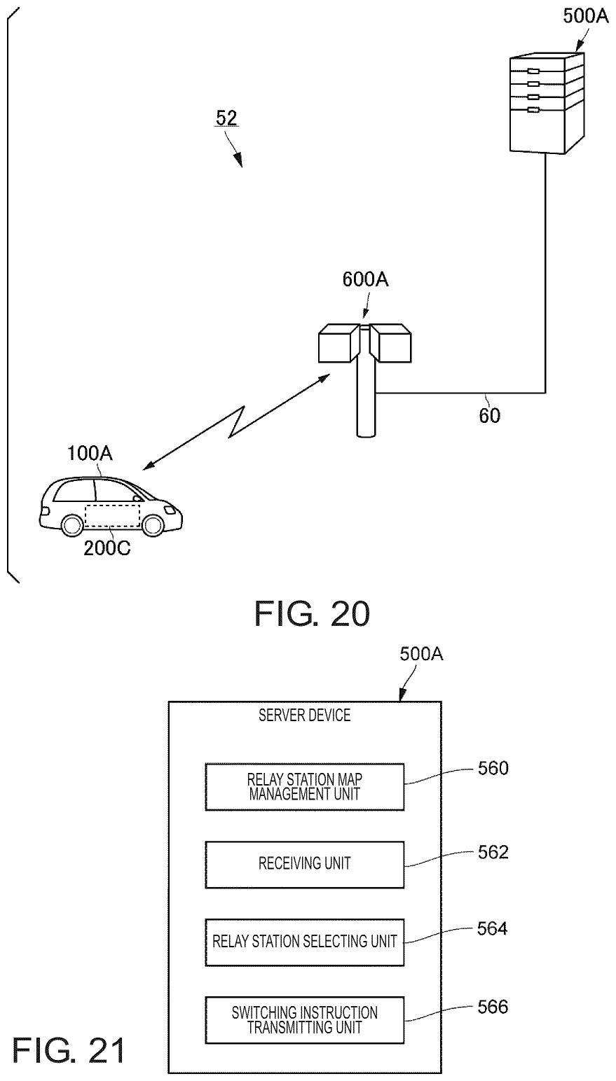

As shown in FIG. 20, a security management system 52 according to the present embodiment includes an in-vehicle device 200C installed in a vehicle 100A, a roadside device 600A that wirelessly communicates with the vehicle 100A, and a server device 500A that communicates with the vehicle 100A via the roadside device 600A. The present embodiment differs from the first and second embodiments in that the server device 500A takes on at least some of the functions of the security management unit described in the first embodiment. Although FIG. 20 shows one roadside device 600A, the security management system may also include a plurality of roadside devices 600A as in the second embodiment.

The roadside device 600A communicates via wire or wirelessly with the server device 500A. In the present embodiment, the roadside device 600A is wired to the server device 500A with a communication line 60. The vehicle 100A that has detected a cyberattack transmits vehicle information to the roadside device 600A. The roadside device 600A transmits the received vehicle information to the server device 500A. The server device 500A, which is an infrastructure device serving as a vehicle-external device, manages relay stations and selects a relay station based on the vehicle information received from the vehicle 100A. The server device 500A transmits information indicating the selected relay station together with a switching instruction to switch the communication path to the vehicle 100A via the roadside device 600A. The vehicle 100A switches the communication path based on the switching instruction transmitted from the server device 500A.

The in-vehicle device 200C installed in the vehicle 100A has the same configuration as the configuration of the in-vehicle device in the second embodiment. The roadside device 600A has a function of a relay station that relays communication between the in-vehicle device 200C and the server device 500A. The server device 500A has the functions of the security management unit, instead of the roadside device 600A.

As shown in FIG. 21, the server device 500A includes a relay station map management unit 560, a receiving unit 562, a relay station selecting unit 564, and a switching instruction transmitting unit 566 as functional units. The relay station map management unit 560 creates a relay station map and manages relay stations with use of the created relay station map. The receiving unit 562 receives vehicle information transmitted from the in-vehicle device 200C (see FIG. 15) via the roadside device 600A. The relay station selecting unit 564 selects a relay station that can be connected to the in-vehicle device 200C of the vehicle 100A and constitutes a path different from the communication path that was in use when a cyberattack was detected, from the relay stations managed by the relay station map management unit 560 based on the received vehicle information. The switching instruction transmitting unit 566 transmits a switching instruction to switch the communication path to a path routed via the relay station selected by the relay station selecting unit 564 to the in-vehicle device 200C (GW device 210C) via the roadside device 600A.

The server device 500A has the same hardware configuration as the hardware configuration of the server device 500 shown in FIG. 7.

### Software Configuration

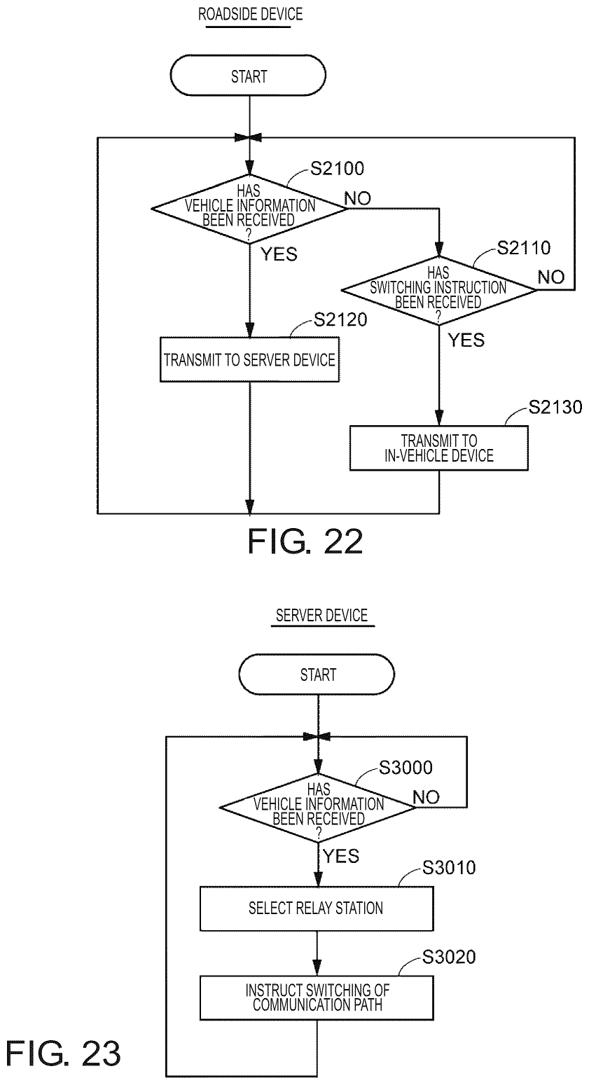

In the roadside device 600A according to the present embodiment, a program shown in FIG. 22 is executed instead of the program shown in FIG. 19.

As shown in FIG. 22, this program includes: step S2100 in which the roadside device determines whether or not vehicle information has been received from the vehicle 100A (see FIG. 20) and the control flow branches according to the determination result; and step S2110 that is executed if it is determined in step S2100 that the vehicle information has not been received, and in which the roadside device determines whether or not a switching instruction has been received from the server device 500A and the control flow branches according to the determination result. If it is determined in step S2110 that the switching instruction has not been received, the control returns to step S2100.

This program further includes: step S2120 that is executed if it is determined in step S2100 that the vehicle information has been received, and in which the received vehicle information is transmitted to the server device 500A; and step S2130 that is executed if it is determined in step S2110 that the switching instruction has been received, and in which the received switching instruction is transmitted to the vehicle 100A. When the processing in step S2120 or the processing in step S2130 is finished, the control returns to step S2100.

The following describes a control structure of a computer program that is executed by the server device 500A according to the present embodiment with reference to FIG. 23. This program starts in response to an operation made by an administrator, for example.

This program includes: step S3000 in which the server device determines whether or not vehicle information has been received from the roadside device 600A (see FIG. 20), and keeps on standby until vehicle information is received; step S3010 that is executed if it is determined in step S3000 that vehicle information has been received, and in which a relay station that can be connected to the vehicle 100A (in-vehicle device 200C) transmitting the vehicle information and satisfies communication requirements for high priority communication is selected based on the received vehicle information with reference to a managed relay station map; and step S3020 that is executed after step S3010 and in which a switching instruction to switch the communication path to a path routed via the selected relay station is transmitted to the roadside device 600A and then the control returns to step S3000.

### Operations

The security management system 52 according to the present embodiment operates as follows.

In the security management system shown in FIG. 20, the vehicle 100A (in-vehicle device 200C) that has detected a cyberattack against the vehicle turns off unnecessary application software or a communication function of the unnecessary application software, and calculates communication requirements for high-priority communication. The in-vehicle device 200C transmits vehicle information to the roadside device 600A.

Upon receiving the vehicle information (YES in step S2100 in FIG. 22), the roadside device 600A transmits the received vehicle information to the server device 500A (step S2120). Upon receiving the vehicle information transmitted from the vehicle 100A (in-vehicle device 200C) via the roadside device 600A (YES in step S3000 in FIG. 23), the server device 500A selects a relay station that can be connected to the vehicle 100A and satisfies the communication requirements for the high priority communication based on the received vehicle information by referring to the relay station map (step S3010). The server device 500A transmits a switching instruction to switch the communication path to a path routed via the selected relay station to the roadside device 600A (step S3020).

Upon receiving the switching instruction from the server device 500A (YES in step S2110 in FIG. 22), the roadside device 600A transmits the received switching instruction to the vehicle 100A (in-vehicle device 200C) (step S2130). Upon receiving the switching instruction from the roadside device 600A (server device 500A), the in-vehicle device 200C switches the communication path based on the switching instruction. Specifically, the in-vehicle device 200C shuts off communication performed when the attack was detected, and starts communication with the relay station specified by the switching instruction. When it is necessary to update the relay station, the in-vehicle device transmits vehicle information to another roadside device 600A through road-vehicle communication. The other roadside device 600A that has received the vehicle information transmits the vehicle information to the server device 500A, receives a switching instruction from the server device 500A, and transmits the switching instruction to the vehicle 100A. Upon receiving the switching instruction from the other roadside device 600A, the vehicle 100A (in-vehicle device 200C) updates the relay station based on the received switching instruction.

When it is no longer necessary to update the relay station because, for example, all high-priority communications have been complete, the in-vehicle device 200C shuts off the communication with the relay station.

### Effects

In the present embodiment, the server device 500A transmits an instruction to switch the communication path to a path routed via a relay station to the vehicle 100A that has detected a cyberattack. That is to say, the server device 500A switches the communication path between the vehicle 100A and the outside of the vehicle through remote control. With this configuration, it is possible to block the path used for the cyberattack and maintain communication between the vehicle 100A and the outside of the vehicle using the path routed via the relay station.

Note that the relay station that relays communication between the in-vehicle device and the server device is not limited to the roadside device (fixed station) and may also be a vehicle (mobile station). That is to say, the security management system 52 according to the present embodiment may include a vehicle (mobile station) instead of the roadside device (fixed station). Also, the security management system 52 may include both the roadside device (fixed station) and a vehicle (mobile station).

The server device 500A having the functions of the security management unit may be a server device of an emergency call center or any other server device.

### Fourth Embodiment

A security management system according to the present embodiment differs from the first embodiment in which the in-vehicle device manages security of the vehicle, in that a server device manages security of the vehicle in the present embodiment. Specifically, the security management system includes a server device that remotely manages security of a vehicle. The server device, which serves as a vehicle-external device, remotely monitors the vehicle by communicating with an in-vehicle device installed in the vehicle, and when the vehicle is subjected to a cyberattack, the server device switches a communication path of the vehicle by remotely controlling the vehicle.

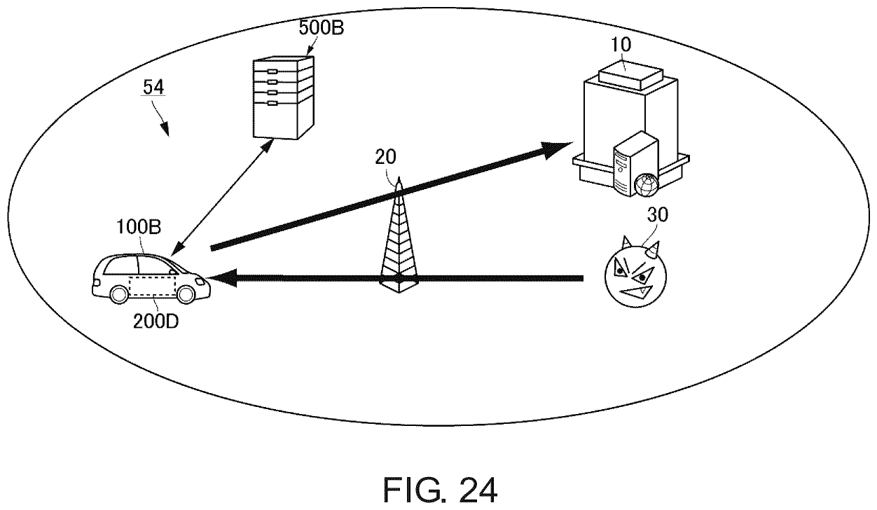

As shown in FIG. 24, a security management system 54 includes a server device 500B. The server device 500B according to the present embodiment communicates with a vehicle 100B (in-vehicle device 200D). The communication between the server device 500B and the vehicle 100B may be wide-area communication such as cellular communication or communication performed via a relay station. The vehicle 100B transmits information for detecting a cyberattack, such as communication data, results of observing communication states or the like, or communication logs, to the server device 500B at constant intervals or suitable timings. The server device 500B has a function of remotely monitoring the vehicle 100B and detecting a cyberattack on the monitored vehicle 100B based on these types of information. After a cyberattack is detected, communication between the server device 500B and the vehicle 100B can be performed via a relay station.

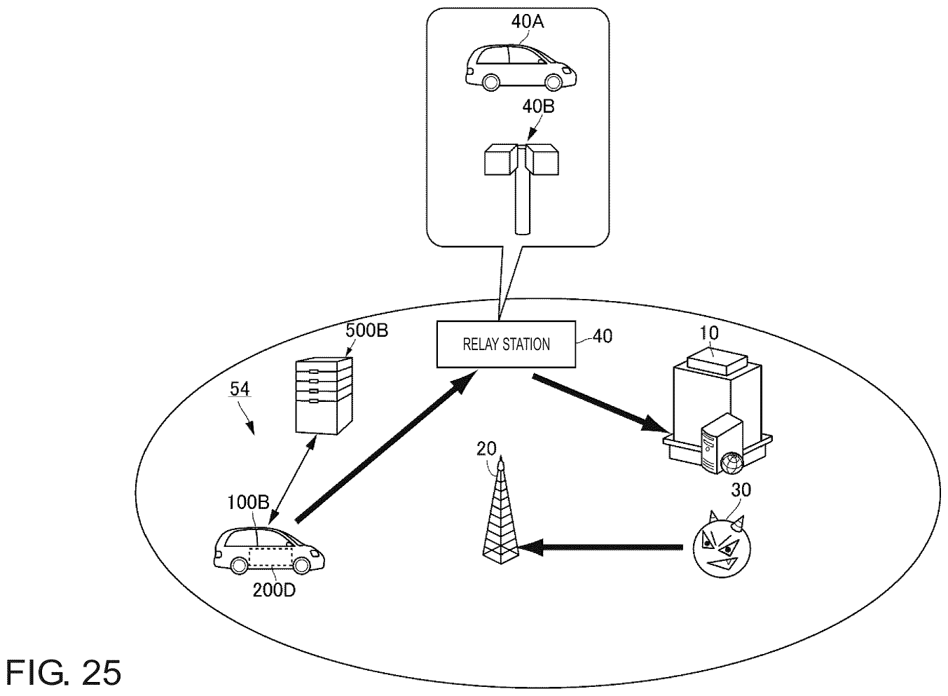

As shown in FIG. 25, when the server device 500B has detected a cyberattack against the vehicle 100B, the server device 500B switches the communication path between the vehicle 100B and an emergency call center 10 from a path routed via a base station 20 to a path routed via a relay station 40 by remotely controlling the vehicle 100B. Thus, the path used for the cyberattack is blocked while the connection to the emergency call center 10 is maintained.

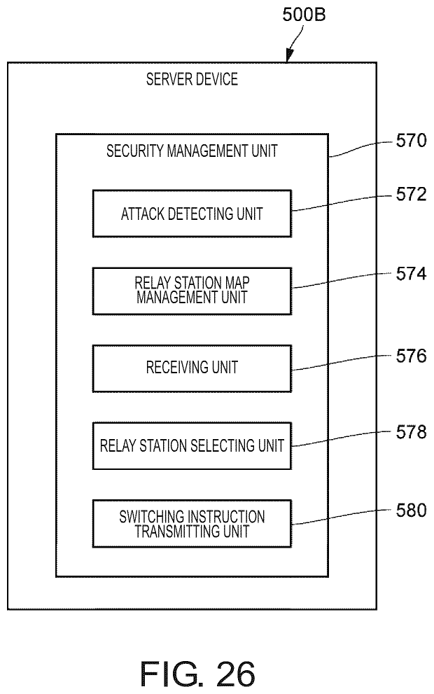

As shown in FIG. 26, the server device 500B includes a security management unit 570 as a functional unit. The security management unit 570 manages security of the vehicle 100B from a remote place. Specifically, the security management unit 570 detects a cyberattack against the vehicle 100B and executes processing for switching a communication path used for communication between the vehicle 100B and the outside of the vehicle, for example. The security management unit 570 includes an attack detecting unit 572, a relay station map management unit 574, a receiving unit 576, a relay station selecting unit 578, and a switching instruction transmitting unit 580 as functional units. When the vehicle 100B is subjected to a cyberattack, the attack detecting unit 572 detects the cyberattack by monitoring communication states, communication logs, and the like of the vehicle 100B from a remote place.

The relay station map management unit 574 creates a relay station map and manages relay stations with use of the created relay station map. The receiving unit 576 receives vehicle information transmitted from the in-vehicle device 200D installed in the vehicle 100B (see FIGS. 24 and 25). The relay station selecting unit 578 selects a relay station that can be connected to the in-vehicle device 200D of the vehicle 100B and constitutes a path different from the communication path that was in use when the cyberattack was detected, from the relay stations managed by the relay station map management unit 574 based on the received vehicle information. The switching instruction transmitting unit 580 transmits a switching instruction to switch the communication path to a path routed via the relay station selected by the relay station selecting unit 578 to the in-vehicle device 200D to switch the communication path of the vehicle 100B from a remote place.

The server device 500B has the same hardware configuration as the hardware configuration of the server device 500 shown in FIG. 7.

### Software Configuration

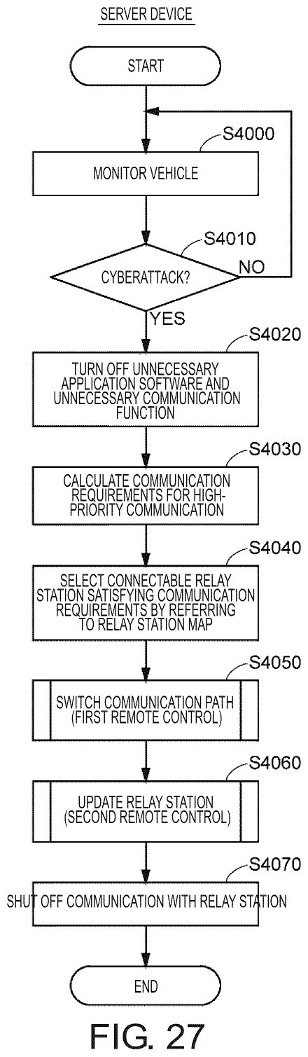

The following describes a control structure of a computer program that is executed by the server device 500B to remotely manage security of the vehicle 100B (see FIGS. 24 and 25), with reference to FIGS. 27 to 29. This program starts in response to an operation made by an administrator, for example.

As shown in FIG. 27, this program includes: step S4000 in which the server device 500B remotely monitors the state of the vehicle 100B based on information (information for detecting a cyberattack, such as communication logs) transmitted from the in-vehicle device 200D (see FIGS. 24 and 25); and step S4010 that is executed after step S4000 and in which the server device 500B determines whether or not a cyberattack has been made on the monitored vehicle 100B. If it is determined in step S4010 that a cyberattack has not been made on the monitored vehicle 100B, the control returns to step S4000, and the processing in steps S4000 and S4010 is repeated until it is determined that a cyberattack has been made.

This program further includes: step S4020 that is executed if it is determined in step S4010 that a cyberattack has been made on the monitored vehicle 100B and in which unnecessary application software whose priority degree is not high is turned off or a communication function of the unnecessary application software is turned off while high-priority communication of the vehicle 100B (see FIGS. 24 and 25) is maintained through remote control performed on the vehicle 100B; step S4030 that is executed after step S4020 and in which communication requirements for the high-priority communication are calculated; step S4040 that is executed after step S4030 and in which a relay station that can be connected to the in-vehicle device 200D and satisfies the calculated communication requirements is selected with reference to the relay station map (relay station table); and step S4050 that is executed after step S4040 and in which processing for switching the communication path of the vehicle 100B is executed through remote control performed on the vehicle 100B.

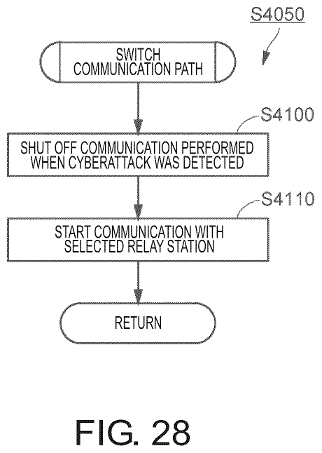

FIG. 28 shows details of the flow of step S4050 shown in FIG. 27. As shown in FIG. 28, this routine includes: step S4100 in which communication with a base station or a communication partner with which the vehicle 100B (see FIGS. 24 and 25) was communicating when the cyberattack was detected is shut off through remote control performed on the vehicle; and step S4110 that is executed after step S4100 and in which the vehicle 100B is caused to start communication with the selected relay station through remote control performed on the vehicle 100B and this routine ends.

Referring back to FIG. 27, this program includes: step S4060 that is executed after step S4050 and in which processing for updating the relay station in the vehicle 100B is executed through remote control performed on the vehicle 100B; and step S4070 that is executed after step S4060 and in which communication between the vehicle 100B and the relay station is shut off through remote control performed on the vehicle 100B and this program ends.

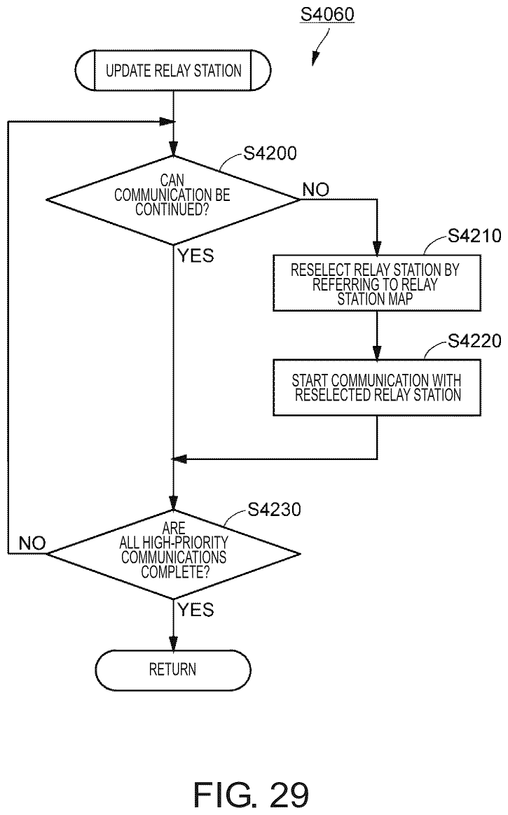

FIG. 29 shows details of the flow of step S4060 shown in FIG. 27. As shown in FIG. 29, this routine includes: step S4200 in which it is determined whether or not communication with the currently connected relay station can be continued in an area in which the vehicle 100B is going to travel, and the control flow branches according to the determination result; step S4210 that is executed if it is determined in step S4200 that the communication cannot be continued, and in which a relay station that can be connected to the in-vehicle device 200D (see FIGS. 24 and 25) and satisfies the calculated communication requirements is reselected with reference to the relay station map (relay station table); step S4220 that is executed after step S4210 and in which the vehicle 100B (see FIGS. 24 and 25) is caused to start communication with the reselected relay station through remote control performed on the vehicle 100B; and step S4230 that is executed if it is determined in step S4200 that the communication with the relay station can be continued, or is executed after step S4220, and in which it is determined whether or not all high priority communications have been complete and the control flow branches according to the determination result.

### Effects

The server device 500B remotely monitors the vehicle 100B, and when the vehicle 100B is subjected to a cyberattack, the attack detecting unit 572 detects the cyberattack. Upon detecting the cyberattack against the vehicle 100B, the server device 500B selects a relay station that can be connected to the in-vehicle device 200D of the vehicle subjected to the cyberattack, from relay stations managed by the relay station map management unit 574. Furthermore, the server device 500B transmits a switching instruction to switch the communication path to a path that is routed via the selected relay station and is different from the communication path that was in use when the cyberattack was detected, to the in-vehicle device 200D of the vehicle 100B. With this configuration, it is possible to block the path used for the cyberattack and maintain communication between the vehicle 100B and the outside of the vehicle using the path routed via the relay station.

The server device 500B having the functions of the security management unit may be a server device of an emergency call center or any other server device.

Other effects of the present embodiment are the same as those of the first embodiment.

### Variations

In the above embodiments, an example is described in which the GW device has the functions of the security management unit, but the present disclosure is not limited to such embodiments. For example, the vehicle-external wireless device may have the functions of the security management unit. However, the vehicle-external wireless device is likely to be exposed to security risks, and therefore, it is desirable to make the GW device have the functions of the security management unit and monitor and control the vehicle-external wireless device as described above. It is also possible to adopt a redundant configuration in which both the GW device and the vehicle-external wireless device have the functions of the security management unit and monitor and control each other. This configuration can further enhance security measures.

In the above embodiments, an example is described in which the in-vehicle device includes the GW device and the vehicle-external wireless device, but the present disclosure is not limited to such embodiments. For example, the in-vehicle device may also be an ECU other than the GW device and the vehicle-external wireless device. That is to say, an ECU may have the functions of the security management unit. It is also possible to install a dedicated ECU having the functions of the security management unit as an in-vehicle device in the vehicle. Furthermore, a configuration is also possible in which a plurality of in-vehicle devices include the security management unit and monitor each other as described above.

In the above embodiments, when an attack has been detected, it is possible to shut off communication with the base station or communication with the communication partner. Furthermore, a configuration is also possible in which the wireless IF (communication path) that was in use when the attack was detected is not used for communication with the destination of switching. However, if only the wireless IF that was in use when the attack was detected satisfies the communication requirements, the wireless IF may be used for communication with the destination of switching.

In the above embodiments, an example is described in which communication requirements for high-priority communication are calculated when the communication path is to be switched and a relay station satisfying the communication requirements is selected, but the present disclosure is not limited to such embodiments. The calculation of communication requirements for high priority communication may be omitted by selecting a relay station that satisfies minimum necessary communication requirements, for example.

In the above embodiment, an example is described in which a CVSS index is used as a predetermined index relating to security risks, but the present disclosure is not limited to such an embodiment. An index other than the CVSS index may also be used as an index relating to security risks.

Each type of processing (each function) in the above embodiments may be realized by processing circuitry including one or more processors. The processing circuitry may be an integrated circuit constituted by a combination of one or more memories, various analog circuits, and various digital circuits, in addition to the one or more processors, for example. A program (commands) for causing the one or more processors to execute the processing described above is stored in the one or more memories. The one or more processors may execute the processing described above in accordance with the program read out from the one or more memories, or in accordance with a logic circuit designed in advance to execute the processing described above. The processors may be various processors applicable to control of a computer, such as a CPU, a GPU, a DSP (Digital Signal Processor), an FPGA (Field Programmable Gate Array), and an ASIC (Application Specific Integrated Circuit). Note that the plurality of processors that are physically separate from each other may execute the processing described above by cooperating with each other. For example, the processors installed in a plurality of computers that are physically separate from each other may execute the processing described above by cooperating with each other via a network such as a LAN (Local Area Network), a WAN (Wide Area Network), or the Internet.

Embodiments obtained by combining the technologies disclosed above as appropriate are also included in the technical scope of the present disclosure.

The embodiments disclosed herein are merely examples, and the present disclosure is not limited to the above embodiments. The scope of the present disclosure is defined by the claims with the detailed description of the disclosure taken into consideration, and encompasses all changes within the meaning and range of equivalency of the claims.

1. An in-vehicle device configured to be installed in a vehicle, the in-vehicle device comprising:
a processor that is configured to:
detect a cyberattack against the vehicle;
manage a plurality of wireless interfaces for performing wireless communication with an outside of the vehicle;
manage a plurality of relay stations that perform communication via any wireless interface of the plurality of wireless interfaces; and
select a relay station of the plurality of relay stations that is connectable to the in-vehicle device,
wherein the processor switches a communication path to a path that is routed via the relay station selected and that is different from a communication path that was in use when the cyberattack was detected when the processor detects the cyberattack.

2. The in-vehicle device according to claim 1, wherein:
the plurality of wireless interfaces includes a first wireless interface for communicating with a base station and a second wireless interface for communicating with a relay station of the plurality of relay stations, and
the processor switches a wireless interface used for wireless communication with the outside of the vehicle from the first wireless interface to the second wireless interface when the processor detects the cyberattack during communication with the base station via the first wireless interface,

3. The in-vehicle device according to claim 1,
wherein the processor calculates a communication requirement required for communication with a predetermined communication partner set in advance, and selects a relay station of the plurality of relay stations that is connectable to the in-vehicle device and satisfies the calculated communication requirement.

4. The in-vehicle device according to claim 1, wherein the processor is further configured to:
manage security strength of the plurality of relay stations, and
select the relay station of the plurality of relay stations further based on the security strength.

5. The in-vehicle device according to claim 1, wherein the processor is further configured to:
manage a predetermined index relating to security risks of the plurality of relay stations, and
select the relay station of the plurality of relay stations further based on the predetermined index relating to the security risks.

6. The in-vehicle device according to claim 1,
wherein the plurality of relay stations includes a mobile station and a fixed station.

7. The in-vehicle device according to claim 1, wherein the processor is further configured to:
update the plurality of relay stations connectable to the in-vehicle device, and
determine whether or not communication with a currently connected relay station is continuable in an area in which the vehicle is going to travel, and selects a new relay station of the plurality of relay stations according to a determination result.

8. The in-vehicle device according to claim 1, wherein the processor is further configured to:
manage the plurality of relay stations with use of a relay station table that includes information of each relay station of the plurality of relay stations in an area in which the vehicle is going to travel, and
select a relay station of the plurality of relay stations connectable to the in-vehicle device in the area in which the vehicle is going to travel, by referring to the relay station table.

9. The in-vehicle device according to claim 8, wherein the processor is further configured to:
obtain a relay station map from an information processing device outside the vehicle by communicating with the information processing device, the relay station map being created by mapping relay stations of the plurality of relay stations that satisfy a predetermined requirement in an area including the area in which the vehicle is going to travel, and
extract information regarding an area corresponding to the area in which the vehicle is going to travel from the relay station map obtained, the information including the relay station table.

10. The in-vehicle device according to claim 8,
the processor is further configured to obtain a relay station map from an information processing device outside the vehicle by communicating with the information processing device, the relay station map including the relay station table and being created by mapping relay stations of the plurality of relay stations that satisfy a predetermined requirement in the area in which the vehicle is going to travel.

11. An in-vehicle device configured to be installed in a vehicle, the in-vehicle device comprising:
a processor that is configured to:
detect a cyberattack against the vehicle;
manage a plurality of wireless interfaces for performing wireless communication with an outside of the vehicle; and
transmit vehicle information to a roadside device outside the vehicle when the cyberattack is detected, the vehicle information including information regarding a communication path that was in use when the cyberattack was detected and information regarding the plurality of wireless interfaces,
wherein the processor switches the communication path to a path routed via a specified relay station in response to an instruction from the roadside device that has received the vehicle information.

12. A roadside device configured to communicate with an in-vehicle device installed in a vehicle,
wherein the in-vehicle device transmits vehicle information to an outside of the vehicle upon detecting a cyberattack against the vehicle, the vehicle information including at least information regarding a communication path that was in use when the cyberattack was detected and information regarding wireless interfaces for performing wireless communication with the outside of the vehicle,
the roadside device comprising a processor that is configured to:
manage a plurality of relay stations;
receive the vehicle information transmitted from the in-vehicle device;
select a relay station of the plurality of relay stations that is connectable to the in-vehicle device of the vehicle and constitutes a path different from the communication path that was in use when the cyberattack was detected, based on the received vehicle information; and
transmit, to the in-vehicle device, an instruction to switch the communication path to a path routed via the relay station selected.

13. A vehicle-external device configured to communicate with an in-vehicle device installed in a vehicle, the vehicle-external device comprising:
a processor that is configured to:
detect a cyberattack against the vehicle;
manage a plurality of relay stations that perform communication via any of a plurality of wireless interfaces installed in the vehicle;
select a relay station of the plurality of relay stations connectable to the in-vehicle device, when the cyberattack against the vehicle is detected; and
transmit, to the in-vehicle device, an instruction to switch a communication path to a path that is routed via the relay station selected and is different from a communication path that was in use when the cyberattack was detected.

14. A security management method to be performed by an in-vehicle device installed in a vehicle, the method comprising;
detecting a cyberattack against the vehicle with use of the in-vehicle device;
selecting a relay station connectable to the in-vehicle device with use of the in-vehicle device from relay stations that perform communication via any of a plurality of wireless interfaces for performing wireless communication with an outside of the vehicle when the cyberattack has been detected; and
switching a communication path with use of the in-vehicle device to a path that is routed via the relay station selected and is different from a communication path that was in use when the cyberattack was detected.

15. A storage medium that stores a computer program that causes a computer installed in a vehicle to:
detect a cyberattack against the vehicle;
manage a plurality of wireless interfaces for performing wireless communication with the-an outside of the vehicle;
manage relay stations that perform communication via any of the plurality of wireless interfaces; and
select a relay station communicably connectable to the computer from the plurality of relay stations,
wherein a communication path is switched to a path that is routed via the relay station selected and is different from a communication path that was in use when the cyberattack was detected when the cyberattack is detected.

16. The in-vehicle device according to claim 2,
wherein the processor calculates a communication requirement required for communication with a predetermined communication partner set in advance, and selects a relay station of the plurality of relay stations that is connectable to the in-vehicle device and satisfies the calculated communication requirement.

17. The in-vehicle device according to claim 2, wherein the processor is further configured to:
manage security strength of the plurality of relay stations, and
select the relay station of the plurality of relay stations further based on the security strength.

18. The in-vehicle device according to claim 3, wherein the processor is further configured to:
manage security strength of the plurality of relay stations, and
select the relay station of the plurality of relay stations further based on the security strength.

19. The in-vehicle device according to claim 2, wherein the processor is further configured to:
manage a predetermined index relating to security risks of the plurality of relay stations, and
select the relay station of the plurality of relay stations further based on the predetermined index relating to the security risks.

20. The in-vehicle device according to claim 3, wherein the processor is further configured to:
manage a predetermined index relating to security risks of the plurality of relay stations, and
select the relay station of the plurality of relay stations further based on the predetermined index relating to the security risks.
